(19) United States
(12) Patent Application Publication
(10) Pub. No.: US 2002/0026641 A1
(43) Pub. Date: Feb. 28, 2002

(54) Communication system

(76) Inventors: Hiromu Mukai, Osaka (JP); Hitoshi Hagimori, Ikoma-shi (JP); Minoru Kuwana, Osaka (JP); Tsutomu Honda, Osaka (JP); Kazuhiko Ishimaru, Osaka (JP); Hideki Nagata, Kobe-shi (JP)

Correspondence Address: Barry E. Bretschneider, Morrison & Foerster LLP, Suite 5500, 2000 Pennsylvania Avenue N.W., Washington, DC, 20006-1888, US

(21) Appl. No.: 09/917,779

(22) Filed: Jul. 31, 2001

(30) Foreign Application Priority Data
Aug. 3, 2000 (JP) 2000-235792

(51) Int. Cl. H04N 7/173

(52) U.S. Cl. 725/105; 348/143; 348/207

(57) ABSTRACT

Communication apparatuses (100) and (200) are provided with image-pickup cameras (110) and (210) respectively. When connected to the communication apparatus (200), the communication apparatus (100) detects whether or not the communication apparatus (200) has an image-pickup camera (210), and, upon detection of the image-pickup camera (210), requests the communication apparatus (200) to transmit control information for controlling the image-pickup camera (210). Based upon the resulting control information, it transmits a control signal for controlling the image-pickup camera (210) to the communication apparatus (200), and also displays an image transmitted and obtained from the communication apparatus (200). In other words, the communication apparatus (100) transmits the control signal for controlling the image-pickup camera (210) on the other side to the receiving end so that the image-pickup camera (210) on the other side is controlled by the control signal. In this manner, the present invention allows the communication apparatus on the image receiving end to easily obtain a necessary image from the communication apparatus on the transmission end.

This application is based on application No. 2000-235792 filed in Japan, the contents of which are hereby incorporated by reference.

### BACKGROUND OF THE INVENTION

1. Field of the Invention

The present invention relates to a communication apparatus that is cable-or radio-connected and a communication system thereof, and, more particularly, concerns a communication apparatus having an image transmitting function or receiving function, and a communication system thereof.

2. Description of the Background Art

In recent years, an image-pickup camera is installed in a portable communication apparatus such as a mobile telephone so that the caller (user) can pick up images of himself or herself and ambient scenery as subjects, and transmit the picked-up image to a communication apparatus on the receiving end, and products having such functions have been put into the market. In communication systems constituted by such communication apparatuses, not only voice information, but also image information can be transmitted so that more information can be received from the transmission end.

However, in the conventional communication apparatus or communication system, the communication apparatus for receiving images has only the functions for simply receiving images transmitted from the transmission end and for displaying the images.

For this reason, even in the case when an attempt is made to display an image that is altered in its image-pickup direction and image-pickup magnification on the communication apparatus on the receiving end, the user of the communication apparatus on the receiving end is not allowed to directly alter these, and needs to ask the other user of the communication apparatus on the transmission end to alter these factors.

In other words, the image transmission in the conventional communication system is one-directionally carried out from the communication apparatus on the transmission end, and it has been difficult for the communication apparatus on the receiving end to obtain desired images efficiently.

### SUMMARY OF THE INVENTION

This present invention is directed to a communication apparatus that communicates with a communication apparatus on the other side.

A communication apparatus in accordance with one aspect of the present invention is provided with: a detector which, during a connected state of communication with the communication apparatus on the other side, detects whether or not the communication apparatus on the other side is provided with an image-pickup device; a control information transmission requesting device which, if the detector detects that the communication apparatus on the other side is provided with an image-pickup device, requests the communication apparatus on the other side to transmit control information for controlling the image-pickup device; and a control signal transmission device which, after having received the control information requested by the control information transmission requesting device, transmits a control signal for controlling the image-pickup device to the communication apparatus on the other side based upon the control information thus obtained.

Thus, it is possible to control the operation of the image-pickup device by sending the control signal suitable for the communication apparatus on the other side. Consequently, it becomes possible for the communication apparatus on the image receiving side to easily obtain a necessary image.

Moreover, the communication apparatus in another aspect of the present invention is provided with: a detector which, during a connected state of communication with the communication apparatus on the other side, detects whether or not the communication apparatus on the other side is provided with an image-pickup device; an assignment information transmission device which, if the detector detects that the communication apparatus on the other side is provided with an image-pickup device, transmits to the communication apparatus on the other side assignment information that makes each of the operations of the image-pickup device and each of the operation signals associated with each other; and a control signal transmission device which, based upon input information from a predetermined operation input means, generates an operation signal to transmit this to the communication apparatus on the other side.

Therefore, it is possible to control the operation of the image-pickup device of the communication apparatus on the other side without the necessity of transmitting a control signal suitable for the communication apparatus on the other side. Consequently, it is possible for the communication apparatus on the image receiving side to easily obtain a necessary image.

The communication apparatus in accordance with still another aspect of the present invention is provided with: an image-pickup device for picking up an image of a subject; a controller for controlling the image-pickup device; and an assignment information storage device for storing the assignment information that makes each of the operations of the image-pickup device and each of the operation signals associated with each other, obtained from the communication apparatus on the other side, and in this arrangement, upon receipt of an operation signal from the communication apparatus on the other side, the operation of the image-pickup device is specified by reference to the assignment information so that the image-pickup device is controlled so as to carry out the corresponding operation.

Therefore, the operation is specified from the operation signal from the communication apparatus on the other side, thereby making it possible to carry out a suitable image-pickup operation.

Moreover, the communication apparatus in accordance with still another aspect of the present invention is provided with the following devices: an image-pickup device for picking up an image of a subject; a controller for controlling the image-pickup device based upon a control signal from the communication apparatus on the other side; and a determination device for permitting or rejecting the controlling operation of the image-pickup device by the controller during a connected state of communication with the communication apparatus on the other side.

Therefore, the communication apparatus makes it possible to permit or reject the image-pickup operation controlled by the communication apparatus on the other side.

Moreover, the present invention is directed to a mobile communication apparatus.

This mobile communication apparatus in accordance with still another aspect of the present invention is provided with the following devices: an image-pickup device for picking up an image of a subject; an image-pickup mode setting device for making the image-pickup mode for operating the image-pickup device effective; and a plurality of number-inputting operation sections for specifying the communication apparatus on the other side so as to carry out a communication with the communication apparatus on the other side, and in this arrangement, in the case when the image-pickup mode is set to be effective by the image-pickup mode setting device, the plurality of number-inputting operation sections function as operation input devices for inputting the contents of the operation of the image-pickup device.

Therefore, it is possible to carry out operation inputs so as to operate the image-pickup device of the communication apparatus on the other side by using minimum operation sections required which are installed in the communication apparatus.

Moreover, this invention is also directed to a communication system.

This communication system in accordance with one aspect of the present invention is provided with: a first communication apparatus; and a second communication apparatus having an image-pickup device that is designed to communicate with the first communication apparatus, and in this arrangement, the second communication apparatus transmits control information for controlling the image-pickup device to the first communication apparatus in a connected state to the first communication apparatus, and the first communication apparatus transmits a control signal for controlling the image-pickup device to the second communication apparatus based upon the control information so as to control the image-pickup device.

Therefore, the first communication apparatus transmits a control signal suitable for the second communication apparatus so that the operation of the image-pickup device is controlled. Thus, the first communication apparatus is allowed to easily obtain a necessary image.

Moreover, the communication system in accordance with still another aspect of the present invention is provided with: a first communication apparatus having a first image-pickup device; and a second communication apparatus having a second image-pickup device that is designed to communicate with the first communication apparatus, and in this arrangement, the first communication apparatus transmits to the second communication apparatus assignment information that makes each of the operations of the first image-pickup device and each of the operation signals associated with each other, and the second communication apparatus stores the assignment information so that, upon receipt of the operation signal from the first communication apparatus, the second communication apparatus refers to the assignment information and specifies the operation of the second image-pickup device so as to control the second image-pickup device.

Therefore, without the necessity of transmitting a control signal suitable for the second communication apparatus, the first communication apparatus can control the operation of the image-pickup device of the second communication apparatus. Thus, the first communication apparatus is allowed to easily obtain a necessary image.

Moreover, the communication system in accordance with another aspect of the present invention is provided with: a first communication apparatus; and a second communication apparatus having an image-pickup device that is designed to communicate with the first communication apparatus, and in this arrangement, the first communication apparatus transmits a control signal to the second communication apparatus, and the second communication apparatus is provided with the following devices: a controller for controlling the image-pickup device based upon the control signal; and a determination device for permitting or rejecting the controlling operation of the image-pickup device by the controller during a connected state of communication with the first communication apparatus.

Therefore, the second communication apparatus makes it possible to permit or reject the image-pickup operation controlled by the communication apparatus on the other side.

As described above, the objective of the present invention is to provide a communication apparatus, a mobile communication apparatus and a communication system, which allow the communication apparatus forming the image receiving side to easily obtain a necessary image.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic drawing that shows a construction of a communication system in accordance with a first preferred embodiment;

FIG. 2 is a drawing that shows one example of the external appearance of a communication apparatus;

FIG. 3 is a block diagram that shows an essential part of an internal structure of a communication apparatus serving as a controlling apparatus;

FIG. 4 is a block diagram that shows an essential part of an internal structure of a communication apparatus serving as an apparatus to be controlled;

FIG. 5 is a drawing that shows one example of a guide screen showing the correlation between operations and camera behaviors;

FIG. 6 is a flow chart that shows a sequence of processes in the communication system in accordance with the first preferred embodiment;

FIG. 7 is a block diagram that shows an essential part of an internal structure of a communication apparatus serving as a controlling apparatus;

FIG. 8 is a block diagram that shows an essential part of an internal structure of a communication apparatus serving as an apparatus to be controlled;

FIG. 9 is a flow chart that shows a sequence of processes in the communication system in accordance with a second preferred embodiment;

FIG. 10 is a block diagram that shows an essential part of an internal structure of a communication apparatus serving as an apparatus to be controlled;

FIG. 11 is a flow chart that shows a sequence of processes in which the image-pickup operation is automatically permitted as a first sequence of processes in a communication system in accordance with a third preferred embodiment;

FIG. 12 is flow chart that shows a sequence of processes in which the image-pickup operation is manually permitted as a second sequence of processes in the communication system in accordance with the third preferred embodiment;

FIG. 13 is a schematic drawing that shows a construction of a communication system in accordance with a fourth preferred embodiment;

FIG. 14 is a drawing that shows one example of the external appearance of a communication apparatus; and

FIG. 15 is a flow chart that shows a sequence of processes in the communication system in accordance with the fourth preferred embodiment.

### DESCRIPTION OF THE PREFERRED EMBODIMENTS

Referring to Figures, the following description will discuss preferred embodiments of the present invention.

<1. First Preferred Embodiment>

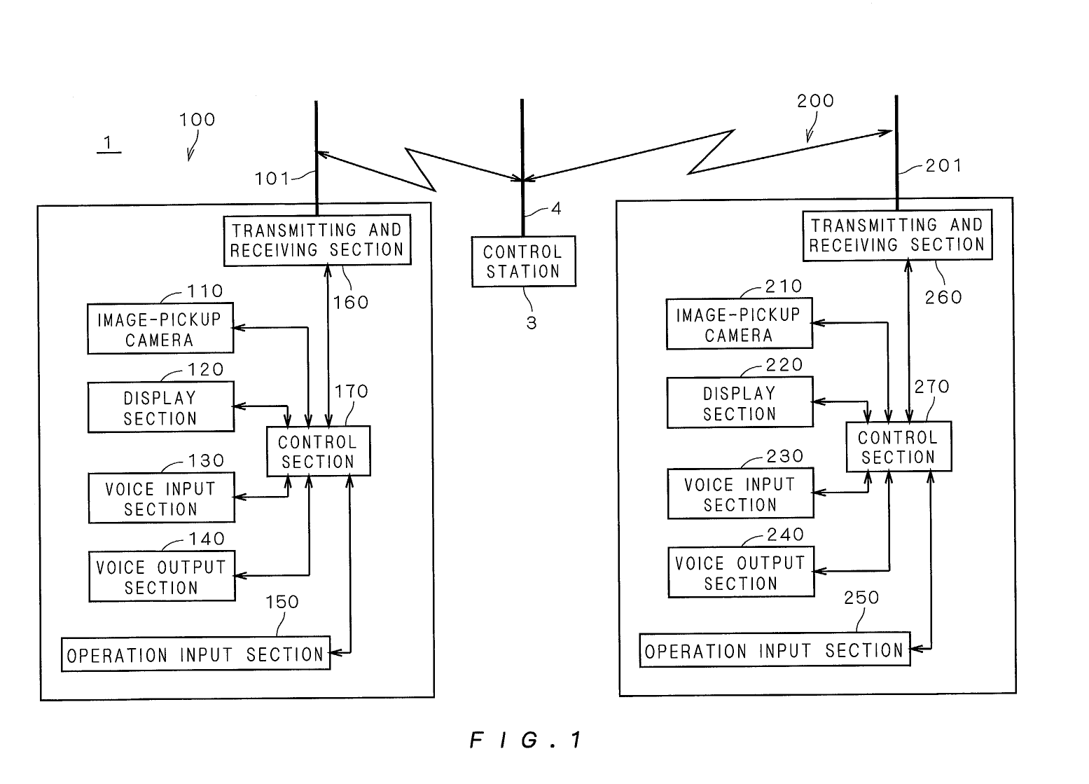

First, an explanation will be given of the first preferred embodiment. FIG. 1 is a schematic drawing that shows a construction of a communication system 1 in accordance with the first preferred embodiment. As illustrated in FIG. 1, this communication system is arranged so that two communication apparatuses 100, 200 are allowed to mutually transmit and receive information through a control station 3. Here, this communication system 1 may be arranged so that, without the control station, the communication apparatus 100 and the communication apparatus 200 are allowed to directly communicate with each other. Moreover, although only one control station is shown in FIG. 1, another control station which is connected thereto through cables may be placed in between.

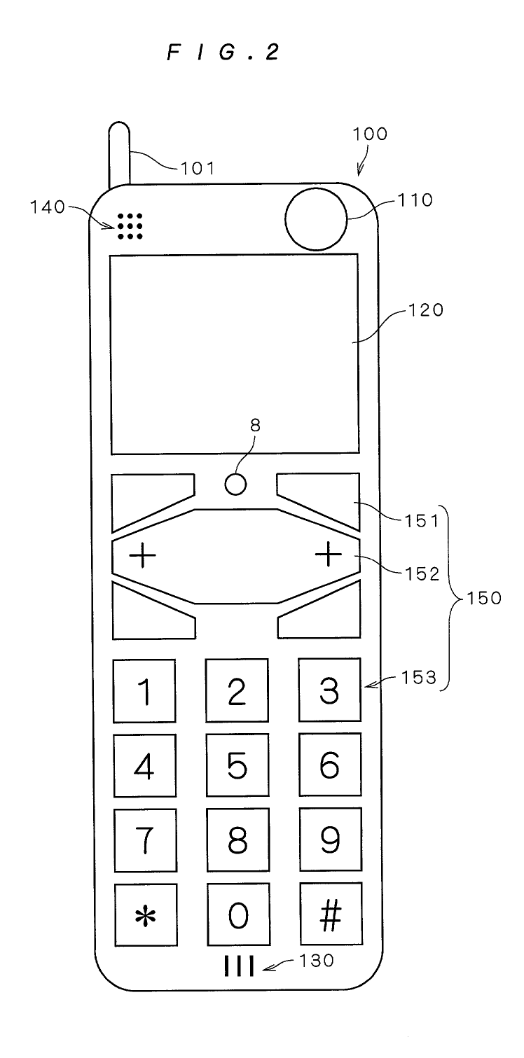

FIG. 2 is a drawing that shows an external appearance of the communication apparatus 100. As illustrated in FIG. 2, the communication apparatus 100 functions as a so-called mobile telephone. A communication antenna 101 is placed on the upper surface side of the communication apparatus 100, and at an upper portion on the front face, an image-pickup camera 110 which can alter the image-pickup direction through a panning operation, a tilting operation, etc., and a voice output section 140 constituted by a speaker, etc. are placed. On the lower stage below this, a display section 120, constituted by a liquid crystal display, etc., for displaying images picked up by the image-pickup camera 110 and images received from a communication apparatus 200 on the transmission end, for displaying other communication information and for displaying an operation guide screen, is installed. On the further lower stage from this, a plurality of operation sections (for example, button keys, a jog dial, a pointing device, etc.), which serve as an operation input section 150 for allowing the caller (user) to input desired operations, are installed. Moreover, at the lowermost portion on the front face, a voice input section 130, constituted by a microphone, etc., for inputting voice is placed. Furthermore, in the vicinity of the center portion below the display section 120, a light-emitting element 8, such as an LED, etc., which is lit up when controlling the communication apparatus on the receiving end, is installed.

Here, in FIG. 2, although the explanation has been given of the communication apparatus 100, the other communication apparatus 200 also has the same construction.

Again in FIG. 1, the communication apparatus 100 is provided with: a control section 170 for controlling the image-pickup camera 110, the display section 120, the voice input section 130, the voice output section 140 and the operation input sections 150, and a transmitting and receiving section 160 for transmitting and receiving information to and from the communication apparatus 200 through the antenna 101, as inner functions.

Moreover, the communication apparatus 200 is also provided with: a control section 270 for controlling an image-pickup camera 210, a display section 220, a voice input section 230, a voice output section 240 and operation input sections 250, and a transmitting and receiving section 260 for transmitting and receiving information to and from the communication apparatus 100 through an antenna 201, as inner functions.

This preferred embodiment exemplifies a case in which, in the communication system 1 having the above-mentioned construction, the communication apparatus 100 controls the operation of the image-pickup camera 210 of the communication apparatus 200 so that an image required by the communication apparatus 100 side is obtained from the communication apparatus 200 on the receiving end.

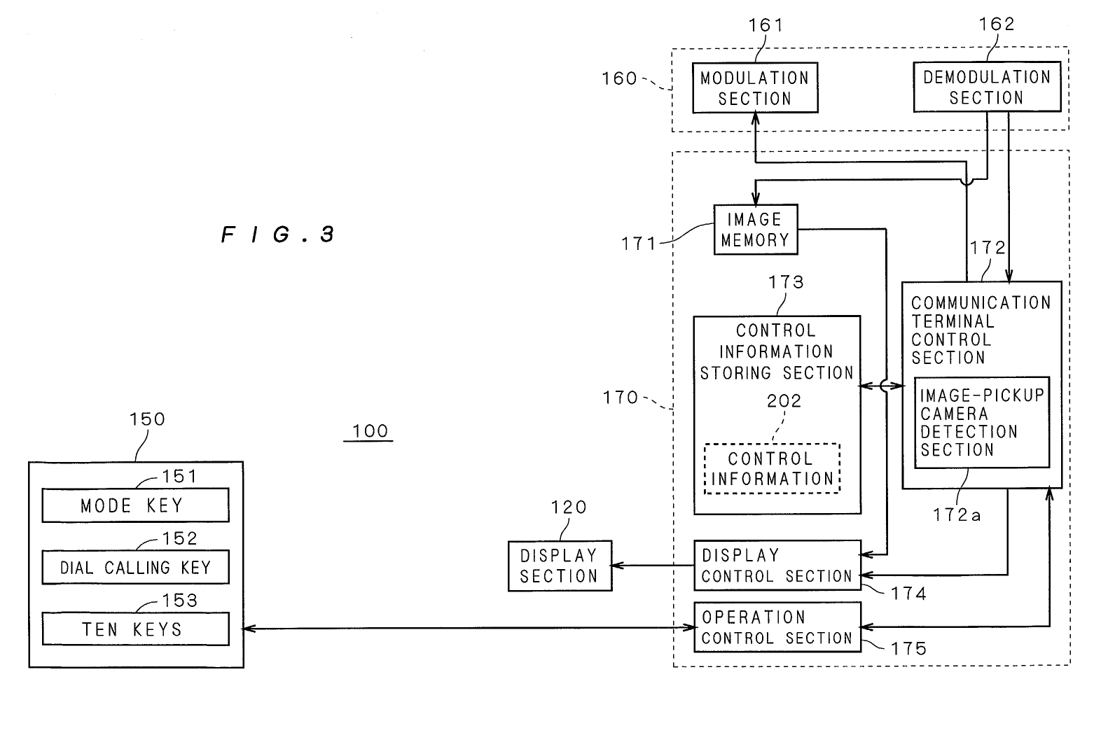

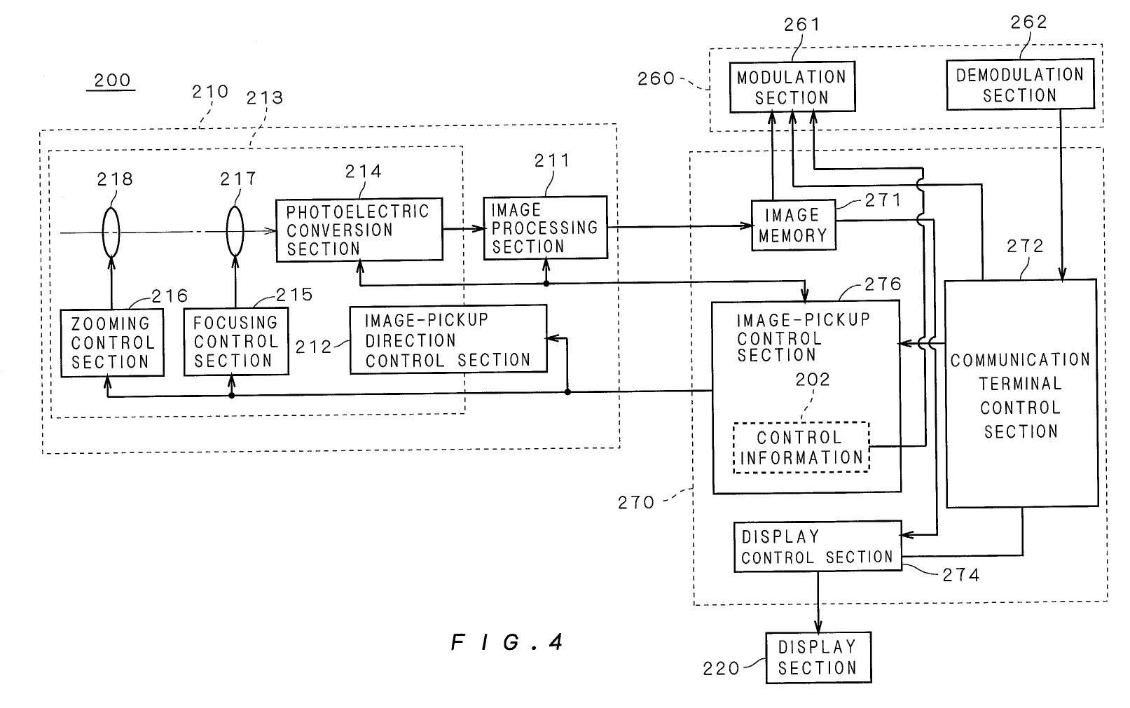

FIG. 3 is a block diagram that shows an essential part in the inner mechanism of the communication apparatus 100 that forms a controlling main body (controlling side), and FIG. 4 is a block diagram that shows an essential part in the inner mechanism of the communication apparatus 200 that forms a control subject (controlled side).

First, an explanation will be given of an essential construction of the communication apparatus 100 forming the controlling main body. In the communication apparatus 100, the transmitting and receiving section 160 is provided with a modulation section 161 for modulating information upon transmitting the information to the communication apparatus 200 and a demodulation section 162 for demodulating the modulated information received from the communication apparatus 200. The transmitting and receiving section 160 has a function for supplying information received from the antenna 101 to the control section 170 and for transmitting information obtained from the control section 170 to the communication apparatus 200 through the antenna 101.

Here, the control section 170 is constituted by an image memory 171 installed for storing images, and sections, such as a communication terminal control section 172, a control information storing section 173, a display control section 174 and an operation control section 175, which are functional sections that are realized by allowing a CPU having a built-in memory to execute a predetermined program.

The communication terminal control section 172 is a controller for controlling the entire operations of the communication apparatus 100. The control information storing section 173 is a storing means for storing control information obtained from the communication apparatus 200 that is a control subject and is constituted by a semiconductor memory, etc. Moreover, the display control section 174 is used for controlling the image display in the display section 120, and the operation control section 175 is used for supplying information inputted from the operation input section 150 to the communication terminal control section 172.

Moreover, a plurality of button keys constituting the operation input section 150 include various button keys such as a mode key 151, a dial calling key 152 and ten keys 153, and predetermined functions are assigned to the respective button keys.

The mode key 151 is a switching button for making switchovers among a first mode for picking up an image by using the image-pickup camera 110 attached to its own body, a second mode for picking up an image by using the image-pickup camera 210 attached to the communication apparatus 200 on the other side, and a third mode in which no image-pickup operation is available. Moreover, the ten keys 153 are number inputting buttons for inputting numbers (that is, telephone number) that specify the communication apparatus 200 so as to carry out communication with the other communication end, the dial calling key 152 is an operation button used for easily calling for the number of the other communication end that has been preliminarily stored.

Moreover, the communication terminal control section 172 is provided with an image-pickup camera detection section 172a. The image-pickup camera detection section 172a has a function for detecting whether or not the communication apparatus 200 is provided with an image-pickup camera in a connected state of communication with the communication apparatus 200. In other words, the image-pickup camera detection section 172a detects whether or not the communication apparatus on the receiving end is provided with an image-pickup camera. For example, in a connected state of communication, the communication apparatuses 100 and 200 mutually transmit information as to whether or not their own apparatus is equipped with a camera to the other side so that the other side is informed of the fact whether or not the apparatus on this side has an image-pickup camera.

Furthermore, in a connected state of communication between the communication apparatus 100 and the communication apparatus 200, if no information as to whether or not it has an image-pickup camera is received from the communication apparatus 200, an inspection signal for inspecting whether or not an image-pickup camera is attached thereto is outputted to the modulation section 161. If no response to the inspection signal is obtained from the communication apparatus 200, or if the response is obtained and it shows that no image-pickup camera is attached, it is determined that no image-pickup camera is attached to the communication apparatus 200.

Here, in the case when the communication apparatus 200 on the other side is provided with an image-pickup camera, the communication terminal control section 172 of the communication apparatus 100 acquires control information for controlling the image-pickup camera 210 of the communication apparatus 200, and stores this in the control information storing section 173. More specifically, when the image-pickup camera detection section 172a of the communication apparatus 100 makes a determination that an image-pickup camera is attached to the communication apparatus 200, it requests the communication apparatus 200 to transmit control information for controlling the image-pickup camera, and acquires the control information 202 sent from the communication apparatus 200 on the other side in accordance with the request to store it in the control information storing section 173.

Next, an explanation will be given of an essential construction of the communication apparatus 200 that is a control subject. In the communication apparatus 200, the transmitting and receiving section 260 is provided with a modulation section 261 and a demodulation section 262 in the same manner as the communication apparatus 100.

Moreover, the control section 270 is constituted by an image memory 271, a communication terminal control section 272, a display control section 274 and an image-pickup control section 276. Here, besides these, a control section, which is the same as that of the communication apparatus 100, is installed therein; however, this is omitted from FIG. 4.

The control information 202 for controlling the operations of the respective sections of the image-pickup camera 210 has been preliminarily stored in the image-pickup control section 276, and based upon the control information 202, the image-pickup camera 210 is controlled by the image-pickup control section 276. Therefore, the image-pickup control section 276 is a controller for controlling the image-pickup camera 210.

The image-pickup camera 210 is an image-pickup device for picking up an image of a subject. The image-pickup camera 210 is provided with an image processing section 211, a pickup direction control section 212 and a zoom optical system 213. Moreover, the zoom optical system 213 is provided with a focusing control section 215, a focusing lens 217, a zooming control section 216, a zooming lens 218 and a photoelectric conversion section 214.

The photoelectric conversion section 214 is constituted by C-MOS sensors, CCD image-pickup sensors, etc., and is arranged so that light rays from a subject that have been made incident thereon through the zooming lens 218 and focusing lens 217 are photoelectric-converted to generate an electrical image signal. The zooming control section 216 is used for altering the magnification of the subject image formed on the photoelectric conversion section 214 by shifting the zooming lens 218 along the light axis. Moreover, the focusing control section 215 shifts the focusing lens 217 along the light axis so that the light-receiving face of the photoelectric conversion section 214 and the focused position of the subject image are made coincident with each other. The zooming optical system 213 is integrally constituted in such a manner that the image-pickup direction control section 212 drives an actuator, not shown, so that the image-pickup direction of the zooming optical system 213 is altered. With respect to the operations for changing the image-pickup direction, for example, operations, such as a panning operation for laterally shifting the image-pickup direction and a tilting operation for longitudinally shifting the image-pickup direction, are used.

The image signal, obtained in the photoelectric conversion section 214, is directed to the image processing section 211, and subjected to various image processes such as gamma correction, etc., and temporarily stored in the image memory 271.

Moreover, based upon the control information 202 preliminarily stored therein, the image-pickup control section 276 individually transmits control signals to the image processing section 211, the image-pickup direction control section 212, the photoelectric conversion section 214, the focusing control section 215 and the zooming control section 216; thus, the control operations are carried out at the time when an image is picked up by the image-pickup camera 210.

The control information 202 is constituted by electrical data in which the operations of the respective parts of the image-pickup camera 210 are made to be associated with the corresponding control signals. Upon picking up an image by the image-pickup camera 210, the image-pickup control section 276 obtains the control signal corresponding to the operation to be carried out by the image-pickup camera 210 from the control information 202, and sends the resulting control signal to the operation subject among the image processing section 211, the image-pickup direction control section 212, the photoelectric conversion section 214, the zooming control section 216 and the focusing control section 215.

For example, in order to alter the image-pickup magnification, the image-pickup control section 276 refers to the control information 202 so as to obtain the corresponding control signal used for altering the magnification, and gives the signal to the zooming control section 216, and also obtains the control signal used for focusing from the control information 202 and the image processing section 211, and gives the signal to the focusing control section 215. As a result, the magnification is altered in the zooming optical system 213 so that an image-pickup operation is carried out at the image-pickup magnification specified by the image-pickup control section 276.

Moreover, in order to alter the image-pickup direction, the image-pickup control section 276 refers to the control information 202 so as to acquire control signals for driving actuators in the panning operation direction or in the tilting operation direction, and gives the resulting signal to the image-pickup direction control section 212. Consequently, the image-pickup direction of the image-pickup camera 210 is altered so that an image-pickup operation is carried out in the image-pickup direction specified by the image-pickup control section 276.

Moreover, in order to pick up a still image by the image-pickup camera 210, the image-pickup control section 276 refers to the control information 202 to obtain a control signal used for releasing a still image, and gives the resulting signal to the photoelectric conversion section 214. Consequently, the photoelectric conversion section 214 is allowed to pick up a still image in synchronized timing with the obtained control signal.

In contrast, in the case when a motion image is picked up by the image-pickup camera 210, the image-pickup control section 276 refers to the control information 202 so as to obtain a control signal for starting to pick up the motion image and a control signal for terminating the image-pickup operation, and gives each of these signals to the photoelectric conversion section 214 in each synchronized timing. The photoelectric conversion section 214 starts picking up motion images upon receipt of the control signal for starting the image-pickup, and terminates picking up motion images upon receipt of the control signal for terminating the image-pickup.

Then, the still image or the motion image, obtained by the photoelectric conversion section 214, is given to the image processing section 211, and based upon the control signal given by the image-pickup control section 276, the image processing section 211 carries out various image processes, and gives the resulting outputs to the image memory 271.

In the control section 270, an image, recorded in the image memory 271, is given to the display control section 274 so that the display control section 274 displays the image on the display section 220. Moreover, the image memory 271 is also designed so that, based upon a command by the communication terminal control section 272, it outputs the recorded image to the modulation section 261. With this arrangement, the image obtained through the image-pickup operation by the image-pickup camera 210 can be transmitted to the communication apparatus 100.

Moreover, upon receipt of a request for transmission of the control signal from the communication apparatus 100 through the modulation section 262, the communication terminal control section 272 outputs the control information 202 stored in the image-pickup control section 276 to the demodulation section 251 in response to the request for transmission. Consequently, the control information 202 for controlling the operation of the image-pickup camera 210 in the communication apparatus 200 is transmitted to the communication apparatus 100 side that forms the controlling main body. Then, as described above, the communication apparatus 100 forming the controlling main body stores the control information 202 obtained from the communication apparatus 200 in the control information storing section 173 (see FIG. 3).

In the communication system 1 designed as described above, the communication apparatus 100 forming the controlling main body is also provided with an image-pickup camera 110, and when the selection mode by the mode key 151 is set to the first mode, the ten keys 153 function as the operation input section for operating and controlling its own image-pickup camera 110, while when the selection is set to the second mode, the ten keys 153 functions as the operation input section for operating and controlling the image-pickup camera 210 of the communication apparatus 200 on the other side.

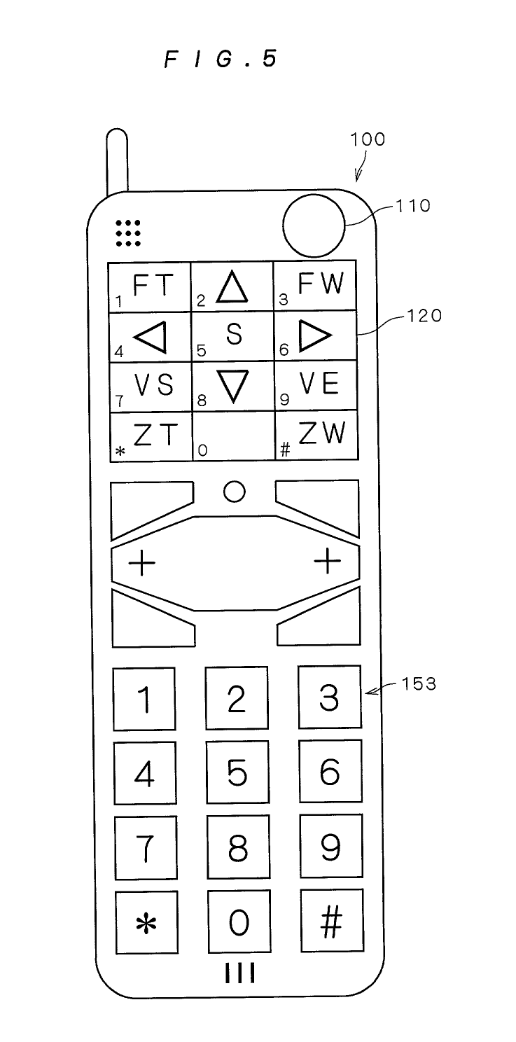

As illustrated in FIG. 5, when the first or second mode is selected, the correlation between the contents of operations with respect to the ten keys 153 and the camera operations is displayed on the display section 120 in predetermined synchronized timing. For example, in the case of FIG. 5, the display section 120 displays the correlation between a plurality of buttons included in the ten keys 153 and the respective operations as follows: buttons “1” and “3” relate to camera operations for focusing images of a distant view and a close view; buttons “2” and “8” relate to camera operations for raising and lowering the image-pickup direction; buttons “4” and “6” relate to camera operations for shifting the image-pickup direction rightward and leftward; a button “5” relates to a shutter operation (image capturing operation) for picking up a still image; buttons “7” and “9” relate to camera operations for starting to pick up an image and for terminating the image-pickup operation at the time when a motion image is picked up; and buttons “*” and “#” relate to camera operations for increasing and reducing the image-pickup magnification.

Referring to the operation guide screen, the user is allowed to easily confirm which button needs to be operated for which action of the image-pickup camera 110 of its own apparatus or the image-pickup camera 210 of the communication apparatus 200 on the other side.

Moreover, at the time when the second mode is selected, the communication terminal control section 172 of the communication apparatus 100 shown in FIG. 3 analyses the contents of the operation of the ten keys 153 by the user, and the actions of the image-pickup camera in response to the contents of the operations are specified. Then, by making an access to the control information storing section 173 to refer to the control information 202 obtained from the communication apparatus 200 on the other side, a control signal corresponding to the specified action is acquired. Thereafter, the communication terminal control section 172 gives the control signal for controlling the image-pickup camera 210 of the communication apparatus 200 on the other side to the modulation section 161 so as to be transmitted to the communication apparatus 200.

In other words, upon controlling the operation of the image-pickup camera 210 of the communication apparatus 200 on the other side, the communication apparatus 100 is allowed to transmit a suitable control signal to the communication apparatus 200.

Therefore, in the communication apparatus 200, upon receipt of the control signal from the communication apparatus 100, the image-pickup control section 276 uses the received control signal so as to control the operation of each of the parts of the image-pickup camera 210. Moreover, the image obtained by the image-pickup camera 210 is transmitted to the communication apparatus 100 through the image memory 271 and the modulation section 261, and in the communication apparatus 100, based upon the operation by the user on the communication apparatus 100, the image is received from the communication apparatus 200 on the other side, and the image is displayed.

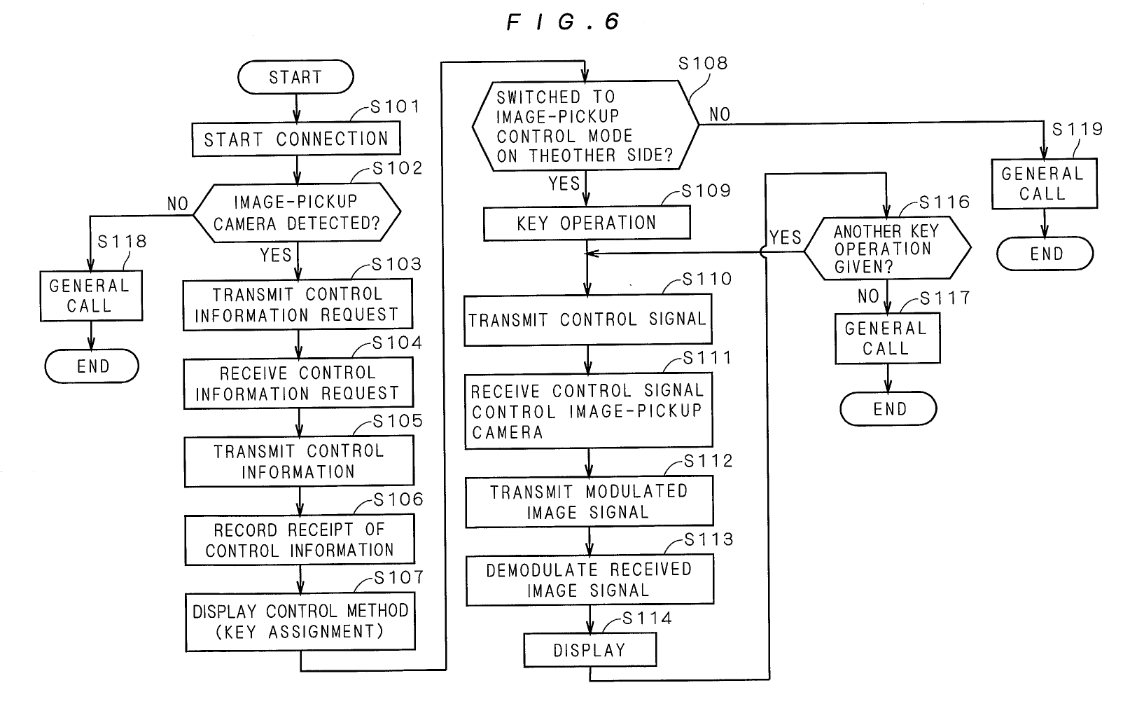

Next, FIG. 6 is a flow chart that shows a sequence of processes in the communication system 1 of the present preferred embodiment.

First, either one of the communication apparatus 100 and the communication apparatus 200 on the other side transmits a request for connection to the other, thereby starting a connecting operation so as to provide a mutually communicatable state (step S101).

Then, the communication apparatus 100 makes a determination as to whether or not the communication apparatus 200 on the other side is provided with an image-pickup camera 210 (step S102). When the determination shows that the communication apparatus 200 is provided with the image-pickup camera 210, the sequence proceeds to step S103, while when the determination shows that no camera is attached thereto, the sequence proceeds to step S118 at which so-called voice communication using only voice is carried out.

At step S103, the communication apparatus 100 requests the communication apparatus 200 to send control information 202 for controlling the operation of the image-pickup camera 210. Then, the communication apparatus 200 receives the request for control information (step S104), and transmits the corresponding control information 202 stored in the image-pickup control section 276 to the communication apparatus 100 (step S105). Upon receipt of the control information 202, the communication apparatus 100 stores it in the control information storing section 173 (step S106).

Based upon the received control information 202, the communication terminal control section 172 of the communication apparatus 100 displays the guide screen (see FIG. 5) on the display section 120 in which the control operations and the operation methods are given in association with each other (step S107). Here, with respect to the timing in which the guide screen is displayed on the display section 120, any predetermined timing, for example, the synchronized timing with the user operation, may be used.

Then, the communication terminal control section 172 of the communication apparatus 100 makes a determination as to whether or not the switchover has been made to the second mode for picking up an image by using the image-pickup camera 210 of the communication apparatus 200 on the other side (step S108), and if the switchover has been made, the sequence proceeds to step S109. Here, in this case, the light-emitting element 8 is lit up so as to inform the other party of the fact that the mode change has been made to control the image-pickup camera 210 on the other side. In contrast, if the mode change has not been carried out, the sequence proceeds to step S119 at which the usual voice communication is carried out.

At step S109, the user of the communication apparatus 100 refers to the guide screen displayed at step S107, and operates the keys contained in the ten keys 153 for operating the image-pickup camera 210 of the communication apparatus 200 on the other side.

In this operation, referring to the control information 202 of the control information storing step 173, the communication terminal control section 172 generates a control signal for the action corresponding to the operation, and transmits this to the communication apparatus 200 on the other side (step S110).

Upon receipt of the control signal from the communication apparatus 100, the communication apparatus 200 operates and controls the image-pickup camera 210 so as to carry out the image-pickup operation based upon the control signal (step S111). As a result, the image-pickup camera 210 of the communication apparatus 200 is allowed to pick up an image in accordance with the command given by the communication apparatus 100.

Then, the communication apparatus 200 modulates the image thus picked up and obtained, and transmits this to the communication apparatus 100 (step S112). Consequently, the communication apparatus 100 receives the image from the communication apparatus 200 on the other side, and demodulates the received image (step S113). Then, the communication apparatus 100 displays the image on the display section 120 so that the user is allowed to confirm the image picked up on the other side (step S114).

Then, the sequence proceeds to step S116, and the communication terminal control section 172 makes a determination as to whether or not the next key operation has been carried out (step S116). Then, if the next key operation has been carried out, the processes from step S110 are repeated so that the operation control of the image-pickup camera 210 attached to the communication apparatus 200 on the other side is carried out.

Here, if no key operation is carried out, the sequence proceeds to step S117 at which the usual voice communication is carried out. Alternatively, the usual voice communication and the image transmission control may be carried out simultaneously.

In this manner in the communication system 1 of the first preferred embodiment, during the connected state of communication with the communication apparatus 200 on the other side, a detection is made as to whether or not the communication apparatus 200 on the other side is provided with an image-pickup camera 210, and if the communication apparatus 200 on the other side is provided with an image-pickup camera 210, the communication apparatus 100 requests the communication apparatus 200 on the other side to transmit control information 202 for controlling the image-pickup camera 210; thus, based upon the control information 202 obtained from the communication apparatus 200 on the other side, the communication apparatus 100 transmits the control signal for controlling the image-pickup camera 210 to the communication apparatus 200 on the other side.

Moreover, in response to the request for transmission from the communication apparatus 100, the communication apparatus 200 that is a control subject transmits to the communication apparatus 100 the control information 202 in which the control signals and the operations of the image-pickup camera 210 are made to be associated with each other, and thereafter, based upon the control signal received from the communication apparatus 100, the image-pickup operation is carried out by controlling the image-pickup camera 210.

Therefore, the operation of the communication apparatus 100 makes it possible to operate and control the image-pickup camera 210 attached to the communication apparatus 200 so that a desired image is obtained on the communication apparatus 100 side in a comparatively easy way.

Moreover, in the present preferred embodiment, the communication terminal control section 172 of the communication apparatus 100 assigns control signals contained in the control information 202 to the respective buttons of the operation input section 150, and the contents of the assigned state are displayed; thus, the user of the communication apparatus 100 is allowed to easily confirm what operation is required upon operating the image-pickup camera 210 on the other side, thereby making it possible to improve the operability.

<2. Second Preferred Embodiment>

Next, an explanation will be given of the second preferred embodiment of the present invention. In the above-mentioned first preferred embodiment, the explanation has been given of a case in which the communication apparatus 100 transmits a control signal that is controlled to conform to the control signal used in the communication apparatus 200 forming a control subject; however, in the present preferred embodiment, an explanation will be given of a case in which a control signal used in the communication apparatus 100 is transmitted to the communication apparatus 200, and this is converted by the communication apparatus 200 to a control signal that conforms to the control of the image-pickup camera 210 of its own.

Here, in this preferred embodiment also, the entire construction of the communication system 1 is the same as that explained in the first preferred embodiment by reference to FIG. 1. Moreover, in this preferred embodiment also, an explanation will be given of a case in which, in a communication system 1, a communication apparatus 100 obtains an image required on the communication apparatus 100 side from a communication apparatus 200 on the other side by controlling the operation of the image-pickup camera 210 of the communication apparatus 200.

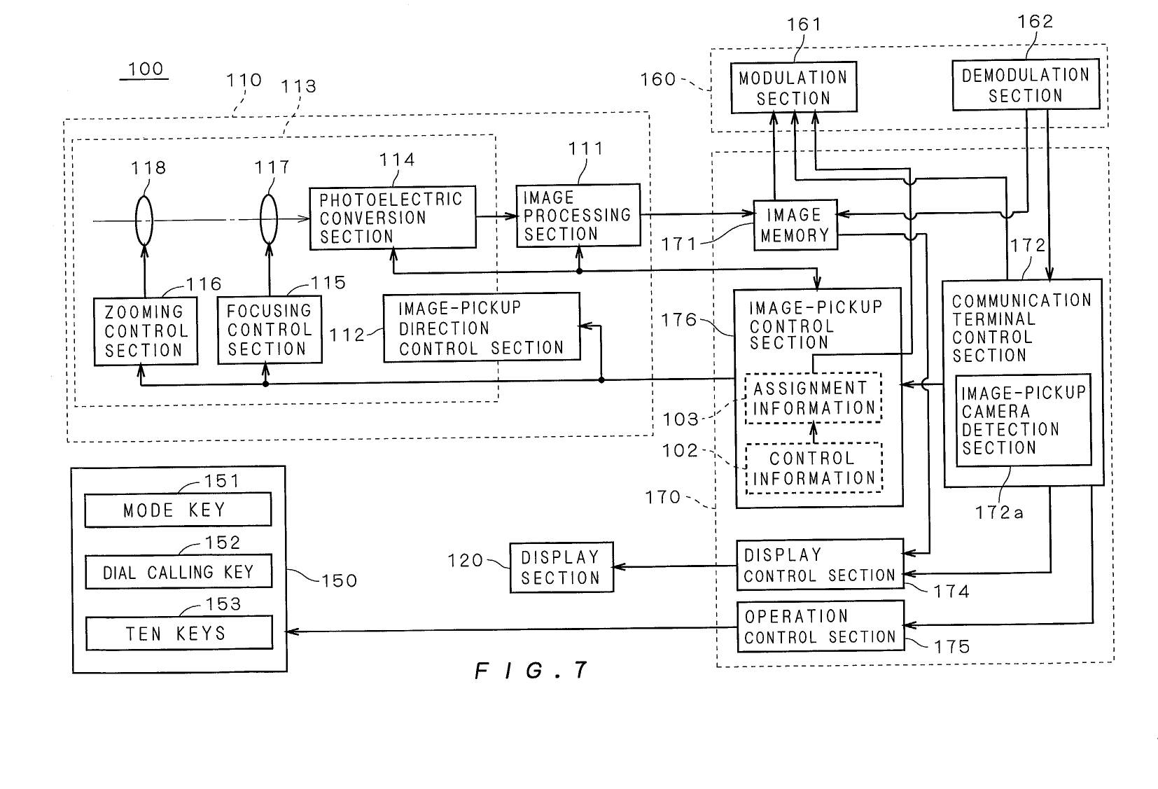

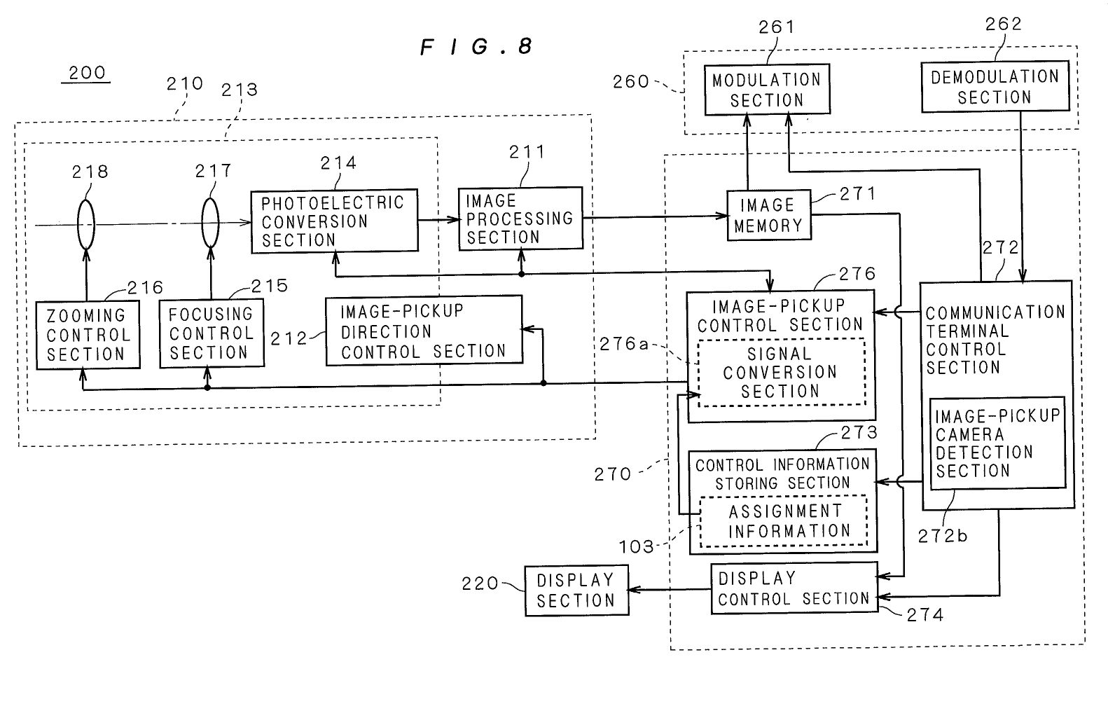

FIG. 7 is a block diagram that shows an essential portion of the inner mechanism of the communication apparatus 100 that forms a controlling main body (controlling side), and FIG. 8 is a block diagram that shows an essential portion of the inner mechanism of the communication apparatus 200 that forms a control subject (controlled side). Here, in FIGS. 7 and 8, those members having the same structures as those explained in the first preferred embodiment are indicated by the same reference numbers (see FIGS. 3 and 4), and the description thereof is omitted.

In this preferred embodiment, an image-pickup control section 176 for controlling an image-pickup camera 110 is installed in a communication apparatus 100 that forms a controlling main body, and control information 102 for controlling the image-pickup camera 110 of its own has been preliminarily stored inside the image-pickup control section 176. This control information 102 has an arrangement in which controlling operations for controlling the respective parts (an image-pickup direction control section 112, etc.) of the image-pickup camera 110 and control signals are made to be associated with each other. Moreover, in the image-pickup control section 176, the contents of the operations of the image-pickup camera 110 are assigned to the respective keys of the operation input section 150, and based upon a button signal (operation signal) generated in response to the button operated on the operation input section 150, the image-pickup control section 176 specifies the corresponding signal, and controls each of the parts of the image-pickup camera 110 by using the control signal.

Moreover, in its connected state for communication with the communication apparatus 200, if the image-pickup detection section 172a makes a determination that the communication apparatus 200 is provided with an image-pickup camera, the communication terminal control section 172 of the communication apparatus 100 gives an instruction to the image-pickup control section 176 so as to transmit assignment information. Upon receipt of the instruction from the communication terminal control section 172, the image-pickup control section 176 generates the assignment information 103 that makes each button signal and each of the operations associated with each other based upon the control information 102, and transmits the resulting information to the communication apparatus 200.

In the communication apparatus 200 that is a control subject, a control information storing section 273 for storing the assignment information 103 for receiving the communication apparatus 100 is installed, and upon receipt of the assignment information 103 from the communication apparatus 100, the communication terminal control section 272 stores the assignment information 103 in the control information storing section 273.

Moreover, the image-pickup control section 276 for controlling the respective parts of the image-pickup camera 210 is provided with a signal conversion section 276a. The signal conversion section 276a has such functions that it reads the assignment information 103 from the control information storing section 273, and converts the button signal obtained from the communication apparatus 100 to a control signal (code) corresponding to the communication apparatus 200. Then, the image-pickup control section 276 properly controls the operations of the image-pickup camera 210 of the communication apparatus 200 by using the control signal generated by the signal conversion section 276a.

In general, in most cases, the communication apparatus 100 and the communication apparatus 200 are not of the same type; therefore, in most cases, the control signal used for controlling the image-pickup camera 110 in the communication apparatus 100 is different from the control signal used for controlling the image-pickup camera 210 in the communication apparatus 200. For this reason, in the present preferred embodiment, the communication apparatus 100 has preliminarily transmits the assignment information 103 that makes each button signal therein and each of the operations associated with each other to the communication apparatus 200 so that, on the communication apparatus 200 side, it is possible to specify the operation corresponding to the button signal used in the communication apparatus 100. Then, in the case when the user of the communication apparatus 100 operates the image-pickup camera 210 of the communication apparatus 200, the user carries out button operations on the operation input section 150 in the communication apparatus 100 so that a button signal corresponding to the operated button is generated by the communication terminal control section 172 is generated, and the button signal is transmitted to the communication apparatus 200. Then, in the communication apparatus 200, the received button signal is converted to an effective control signal of its own, thereby making it possible to carry out a proper image-pickup operation.

In other words, as described in this preferred embodiment, the communication apparatus 100 on the controlling side preliminarily transmits the assignment information 103 to the communication apparatus 200 on the controlled side; therefore, even when the communication apparatus 100 has not recognized the control signal to be used in the communication apparatus 200 on the other side, it is possible to properly control the image-pickup camera 210 of the communication apparatus 200 on the other side. Moreover, in the communication apparatus 200 on the controlled side also, the assignment information 103 has been preliminarily received and stored from the communication apparatus 100; therefore, in the case when a button signal is received from the communication apparatus 100 later, the communication apparatus 200 easily specifies the button signal as to which operation of the image-pickup camera 210 the button signal corresponds to, thereby making it possible properly generate a control signal corresponding the operation in the signal conversion section 276a.

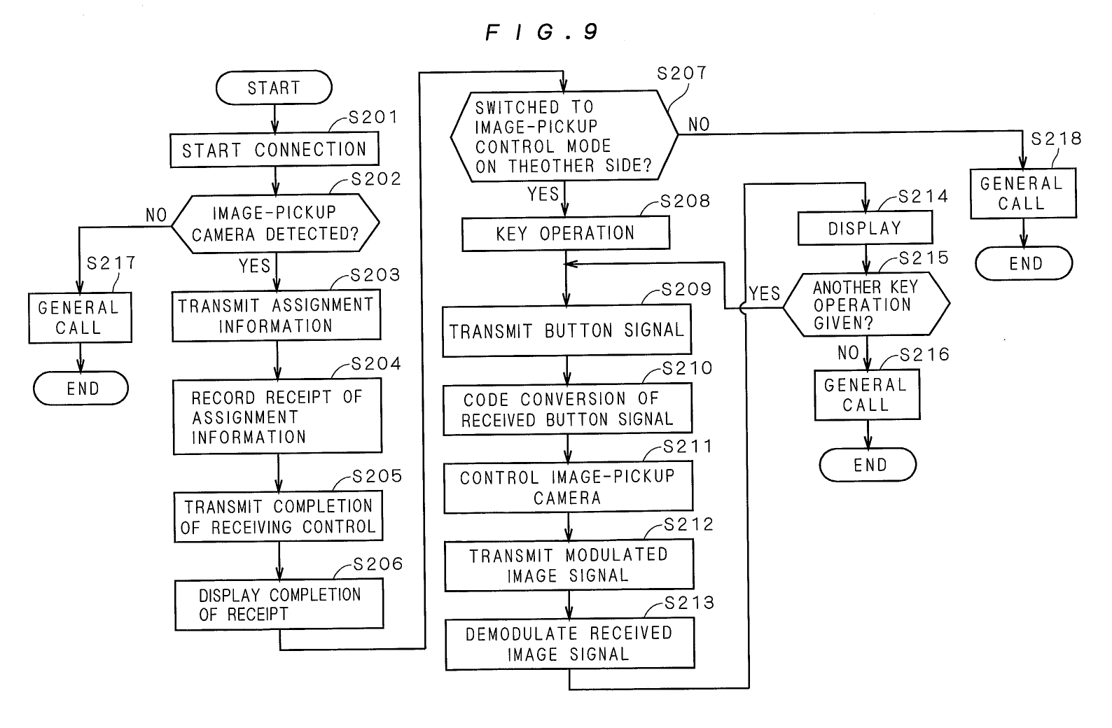

Next, an explanation will be given of a sequence of processes in this preferred embodiment. FIG. 9 shows a flow chart indicating the sequence of processes in the communication system 1 of the present preferred embodiment.

First, either one of the communication apparatus 100 and the communication apparatus 200 on the other side transmits a request for connection to the other, thereby starting a connecting operation so as to provide a mutually communicatable state (step S201).

Then, the communication apparatus 100 makes a determination as to whether or not the communication apparatus 200 on the other side is provided with an image-pickup camera 210 by using the function of the image-pickup camera detection section 172a (step S202). When the determination shows that the communication apparatus 200 is provided with an image-pickup camera 210, the sequence proceeds to step S203, while when the determination shows that no camera is attached thereto, the sequence proceeds to step S217 at which a usual communication using only voice is carried out.

At step S203, the communication apparatus 100 sends assignment information 103 to the communication apparatus 200. Upon receipt of the assignment information 103, the communication apparatus 200 stores the information in the control information storing section 273 (step S204). Upon completion of the recording, the communication apparatus 200 makes a transmission to the communication apparatus 100 so as to inform it of the completion of the receiving and recording controls of the assignment information (step S205).

Upon receipt of the information of completion, the communication terminal control section 172 of the communication apparatus 100 displays the guide screen (see FIG. 5) on the display section 120 in which the control operations and the operation methods are given in association with each other (step S206). Here, with respect to the timing in which the guide screen is displayed on the display section 120, any predetermined timing, for example, the synchronized timing with the user operation, may be used. The display of the guide screen allows the user of the communication apparatus 100 to recognize what operations should be carried out upon operating the image-pickup camera 210 of the communication apparatus 200 on the other side. In particular, in the present preferred embodiment, the operations for operating the image-pickup camera 210 of the communication apparatus 200 on the other side can be made coincident with the operations for operating the image-pickup camera 110 attached to the communication apparatus 100; therefore, the user is allowed to operate either one of the image-pickup cameras 110 and 210 under a unified operation environment. Moreover, depending on specifications of the respective communication apparatuses, there might be any functions that are unusable; in such a case, those functions may be displayed so that the user of the communication apparatus 100 is allowed to confirm them, thereby making the device more convenient.

Then, the communication terminal control section 172 of the communication apparatus 100 makes a determination as to whether or not the switchover has been made to the second mode for picking up an image by using the image-pickup camera 210 of the communication apparatus 200 on the other side (step S207); thus, if the switchover has been made, the sequence proceeds to step S208, and if the mode change has not been carried out, the sequence proceeds to step S218 at which the usual voice communication is carried out.

At step S208, the user of the communication apparatus 100 refers to the guide screen displayed at step S206, and operates the keys contained in the ten keys 150 for operating the image-pickup camera 210 of the communication apparatus 200 on the other side.

This operation allows the communication terminal control section 172 to generate a button signal corresponding to the button key thus operated, and also to transmit the button signal to the communication apparatus 200 on the other side (step S209).

Upon receipt of the button signal from the communication apparatus 100, the communication apparatus 200 specifies the operation requested to the image-pickup camera 210 based upon the assignment information 103 that has already been received and recorded, and generates a control signal in accordance with the operation (step S210). In other words, the button signal is converted to a control signal (code) that is effective in the communication apparatus 200.

Based upon the control signal generated by the signal conversion section 276a, the image-pickup section 276 controls the operation of the image-pickup camera 210, and carries out the image-pickup operation in accordance with the control signal (step S211). As a result, the image-pickup camera 210 of the communication apparatus 200 is allowed to pick up an image suitable for the instruction from the communication apparatus 100.

Then, the communication apparatus 200 modulates the image obtained by the image-pickup operation, and transmits this to the communication apparatus 100 (step S212). Consequently, the communication apparatus 100 is allowed to receive the image from the communication apparatus 200 on the other side, and demodulates the received image (step S213). The communication apparatus 100 displays the received image on the display section 120, and allows the user to confirm the image picked up by the apparatus on the other side (step S214).

Thereafter, the sequence proceeds to step S215 at which the communication terminal control section 172 of the communication apparatus 100 makes a determination as to whether or not the next key operation has been carried out. If the next key operation has been carried out, the processes from the step S209 are repeated so that the control operation of the image-pickup camera 210 attached to the communication apparatus 200 is carried out.

In contrast, if the next key operation is not carried out, the sequence proceeds to step S216 at which the usual voice communication is carried out. Alternatively, the usual voice communication and the image transmission control may be carried out simultaneously.

In this manner in the communication system 1 of the second preferred embodiment, during the connected state of communication with the communication apparatus 200 on the other side, the communication apparatus 100 detects whether or not the communication apparatus 200 on the other side is provided with an image-pickup camera 210, and if the communication apparatus 200 on the other side is provided with an image-pickup camera 210, the communication apparatus 100 requests the communication apparatus 200 on the other side to transmit the assignment information 103 that makes each button signal therein and each of the operations associated with each other at the time when the image-pickup camera 210 on the communication apparatus 200 on the other side is operated. Then, upon controlling the image-pickup camera 210 attached to the communication apparatus 200 on the other side, a button signal is generated in response to the button key operated by the user; thus, it is possible to control the operation of the image-pickup camera 210 properly by transmitting only the button signal to the communication apparatus 200 on the other side.

Moreover, the communication apparatus 200 on the controlled side preliminarily records the assignment information 103 received from the communication apparatus 100, and upon receipt of the button signal from the communication apparatus 100, can easily specify the operation corresponding to the button signal by reference to the assignment information 103. In this manner, it is possible to control the image-pickup camera 210, and also to carry out the image-pickup operation by properly controlling the image-pickup camera 210 based upon the button signal received from the communication apparatus 100.

As described above, in the present preferred embodiment also, the operation of the communication apparatus 100 makes it possible to operate and control the image-pickup camera 210 attached to the communication apparatus 200 so that a desired image is obtained on the communication apparatus 100 side in a comparatively easy way.

<3. Third Preferred Embodiment>

Next, an explanation will be given of the third preferred embodiment of the present invention. In the above-mentioned first and second preferred embodiments, the explanations have been given of a case in which two communication apparatuses that are connected to each other so as to communicate with each other are allowed to control the operation of the image-pickup camera on the other side so as to pick up and acquire a desired image. In this case, however, viewed from the standpoint of the users of the communication apparatuses, it might be inconvenient if their own communication apparatus is unintentionally controlled by the communication apparatus on the other side so as to pick up the ambient image. Therefore, in this preferred embodiment, an explanation will be given of a structural example which has such a function that the control of the image-pickup camera of its own by the communication apparatus on the other side can be permitted or rejected.

Here, in this preferred embodiment also, the entire construction of the communication system 1 is the same as that explained in the first preferred embodiment by reference to FIG. 1. Moreover, in this preferred embodiment also, an explanation will be given of a case in which, in a communication system 1, a communication apparatus 100 obtains an image required on the communication apparatus 100 side from a communication apparatus 200 on the other side by controlling the operation of the image-pickup camera 210 of the communication apparatus 200.

The inner mechanism of the communication apparatus 100 that forms a controlling main body (controlling side) is the same as that explained in the second preferred embodiment, and the communication apparatus 100 transmits assignment information 103 to the communication apparatus 200 on the other side, and then controls the operation of the image-pickup camera 210 by transmitting a button signal later. However, in the present preferred embodiment, upon transmitting the assignment information 103, identification information inherent to the communication apparatus 100 is also transmitted to the communication apparatus 100.

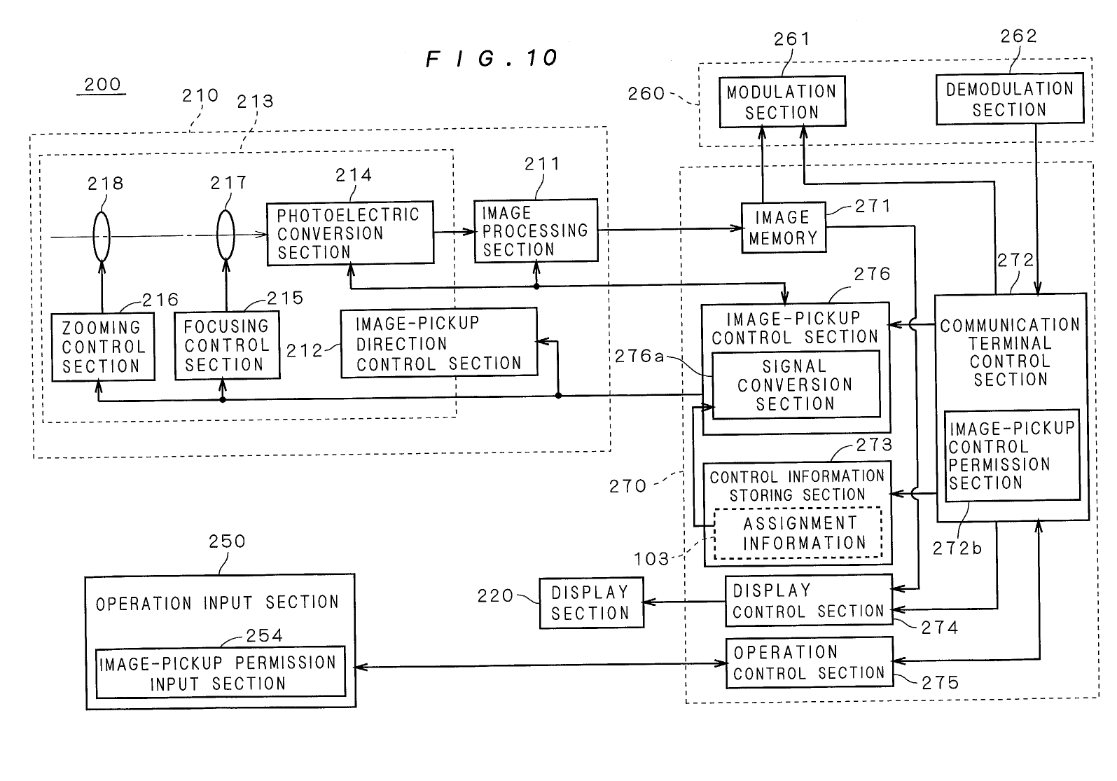

FIG. 10 is a block diagram that shows an essential portion of the inner mechanism of the communication apparatus 200 that forms a control subject (controlled side). Here, in FIG. 10, those members having the same structures as those explained in the first preferred embodiment are indicated by the same reference numbers, and the description thereof is omitted.

An image-pickup permission input section 254 for making a selection as to whether or not the control of the image-pickup camera 210 on the other side is permitted is installed in an operation input section 250 of the communication apparatus 200, and an image-pickup control permission section 272b for making a determination as to whether or not the image-pickup control by the apparatus on the other side is permitted is installed in the communication terminal control section 272.

Moreover, identification information that is set so as to permit the image-pickup control is preliminarily given to the communication terminal control section 272 so that, upon receipt of the assignment information 103 as well as the identification information from the communication apparatus 100, a determination is made as to whether or not the received identification information is coincident with any of the identification information given as the table data.

If there is any coincident information, the assignment information 103 from the communication apparatus 100 is recorded in the control information storing section 273 so that the operation control of the image-pickup camera 210 by the communication apparatus 100 is set in a permissible state.

In the case when no identification information exists, the communication terminal control section 272 provides a confirmation display for the image-pickup permission on the display section 220 through the display control section 274, thereby informing the user of the fact that there is a request for the image-pickup controlling operation from the other side.

Then, the user makes a selection through an input to the image-pickup permission section 254 as to whether or not the image-pickup control is permitted. If the input permission is obtained from the image-pickup control permission section 272b, the assignment information 103 from the communication apparatus 100 is recorded in the control information recording section 273 so that the operation control of the image-pickup camera 210 by the communication apparatus 100 is set in the permissible state. In contrast, if the input permission is not obtained, the operation control of the image-pickup camera 210 is set in an rejected state.

Moreover, upon receipt of a button signal from the communication apparatus 100, the communication terminal control section 272 allows the image-pickup control permission section 272b to determine whether or not the image-pickup control is in the permissible state, and to determine whether or not the received button signal should be transmitted to the image-pickup control section 276.

For example, in the case when the image-pickup control by the apparatus on the other side is in the permissible state, upon receipt of the button signal from the communication apparatus 100, the communication terminal control section 272 properly transmits the button signal to the image-pickup control section 276 so that the signal conversion is carried out by the image-pickup control section 276, thereby making it possible to execute the operation control of the image-pickup camera 210.

In contrast, in the case when the image-pickup control by the apparatus on the other side is in the non-permissible state, even if the communication terminal control section 272 receives a button signal from the communication apparatus 100, the button signal is not transmitted to the image-pickup control section 276, with the result that the operation control of the image-pickup camera 210 is not executed by the image-pickup control section 276.

In other words, the present preferred embodiment has an arrangement in which the image-pickup control permission section 272b automatically permits or rejects the image-pickup control based upon the identification information of the communication apparatus 100 on the other side, or it manually permits or rejects the image-pickup control based upon the operation given to the image-pickup permission input section 254.

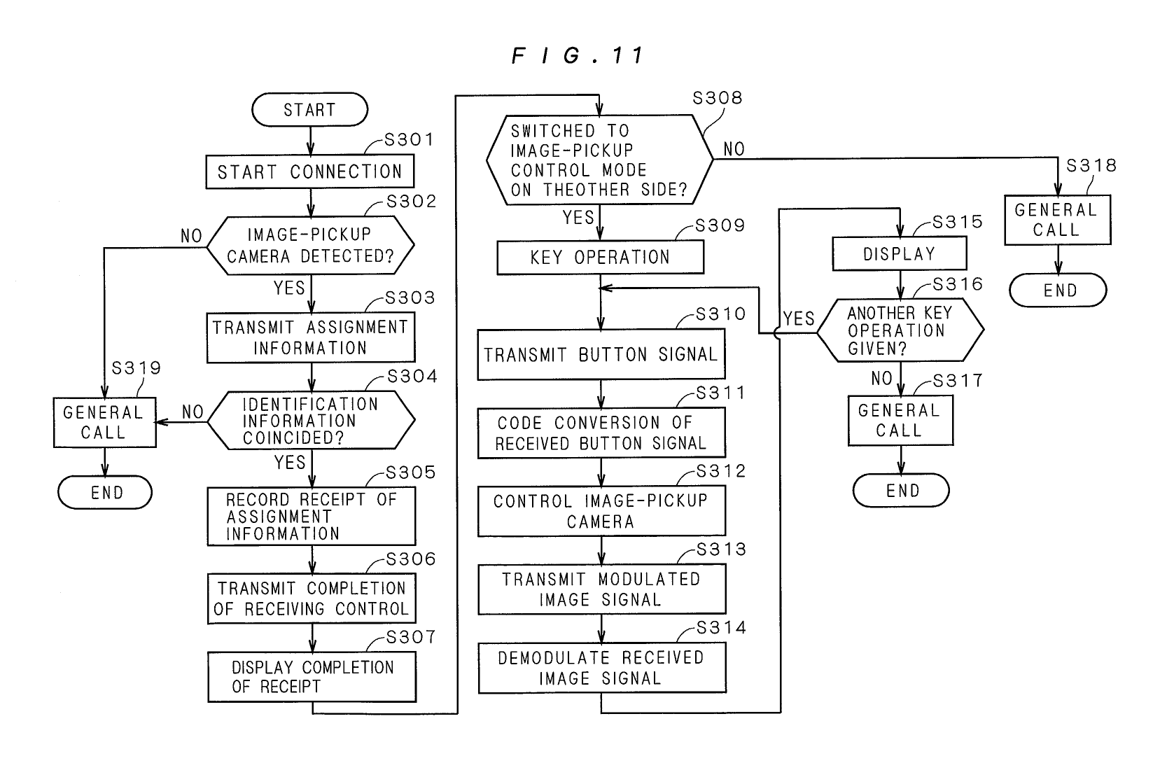

Next, an explanation will be given of a sequence of processes in this preferred embodiment. FIG. 11 shows a flow chart indicating the first sequence of processes in the communication system 1 of the present preferred embodiment, in which the image-pickup control is automatically given.

First, either one of the communication apparatus 100 and the communication apparatus 200 on the other side transmits a request for connection to the other, thereby starting a connecting operation so as to provide a mutually communicatable state (step S301).

Then, the communication apparatus 100 makes a determination as to whether or not the communication apparatus 200 on the other side is provided with an image-pickup camera 210 by using the function of the image-pickup camera detection section 172a (step S302). When the determination shows that the communication apparatus 200 is provided with an image-pickup camera 210, the sequence proceeds to step S303, while when the determination shows that no camera is attached thereto, the sequence proceeds to step S319 at which a usual communication using only voice is carried out.

At step S303, the communication apparatus 100 sends assignment information 103 to the communication apparatus 200. At this time, identification information inherent to the communication apparatus 100 is simultaneously transmitted. Upon receipt of the identification information, the communication apparatus 200 retrieves the table data for the identification information (step S304). Here, in the case when any data coincident with the identification information exists in the table data, the image-pickup control of the image-pickup camera 210 by the communication apparatus 100 is set in a permissible state, and the sequence then proceeds to step S305, while in the case when such data is not included, the sequence proceeds to step S319 at which a usual voice communication is carried out.

At step S305, the communication apparatus 200 stores the assignment information in the control information storing section 273 (step S305). Upon completion of the recording, the communication apparatus 200 transmits the corresponding signal to the communication apparatus 100 so as to inform it of the completion of the receiving and recording controls of the assignment information (step S306).

Upon receipt of the information of completion, the communication terminal control section 172 of the communication apparatus 100 displays the guide screen on the display section 120 in which the control operations and the operation methods are given in association with each other (step S307).

Then, the communication terminal control section 172 of the communication apparatus 100 makes a determination as to whether or not the switchover has been made to the second mode for picking up an image by using the image-pickup camera 210 of the communication apparatus 200 on the other side (step S308); thus, if the switchover has been made, the sequence proceeds to step S309, and if the mode change has not been carried out, the sequence proceeds to step S318 at which the usual voice communication is carried out.

At step S309, the user of the communication apparatus 100 refers to the guide screen displayed at step S307, and operates a key included in the ten keys 153 for operating the image-pickup camera 210 of the communication apparatus 200 on the other side.

This operation allows the communication terminal control section 172 to generate a button signal corresponding to the button key thus operated, and also to transmit the button signal to the communication apparatus 200 on the other side (step S310).

Upon receipt of the button signal from the communication apparatus 100, the communication apparatus 200 specifies the operation requested to the image-pickup camera 210 based upon the assignment information 103 that has already been received and recorded, and generates a control signal in accordance with the operation (step S311). In other words, the button signal is converted to a control signal (code) that is effective in the communication apparatus 200.

Based upon the control signal generated by the signal conversion section 276a, the image-pickup section 276 controls the operation of the image-pickup camera 210, and carries out the image-pickup operation in accordance with the control signal (step S312). As a result, the image-pickup camera 210 of the communication apparatus 200 is allowed to pick up an image suitable for the instruction from the communication apparatus 100.

Then, the communication apparatus 200 modulates the image obtained by the image-pickup operation, and transmits this to the communication apparatus 100 (step S313). Consequently, the communication apparatus 100 is allowed to receive the image from the communication apparatus 200 on the other side, and demodulates the received image (step S314). The communication apparatus 100 displays the received image on the display section 120, and allows the user to confirm the image picked up by the apparatus on the other side (step S315).

Thereafter, the sequence proceeds to step S316 at which the communication terminal control section 172 of the communication apparatus 100 makes a determination as to whether or not the next key operation has been carried out. If the next key operation has been carried out, the processes from the step S310 are repeated so that the control operation of the image-pickup camera 210 attached to the communication apparatus 200 is carried out.

In contrast, if the next key operation is not carried out, the sequence proceeds to step S317 at which the usual voice communication is carried out.

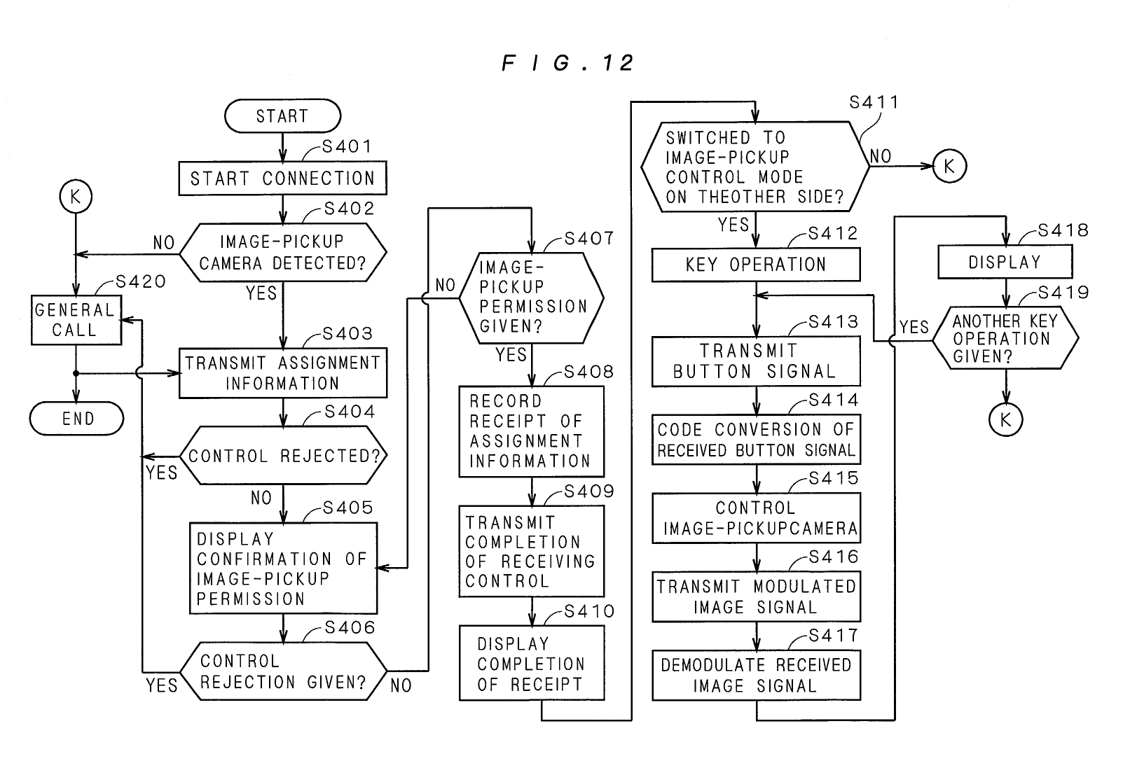

FIG. 12 shows a flow chart indicating the second sequence of processes in the communication system 1 of the present preferred embodiment, in which the image-pickup control is manually given.

First, either one of the communication apparatus 100 and the communication apparatus 200 on the other side transmits a request for connection to the other, thereby starting a connecting operation so as to provide a mutually communicatable state (step S401).

Then, the communication apparatus 100 makes a determination as to whether or not the communication apparatus 200 on the other side is provided with an image-pickup camera 210 by using the function of the image-pickup camera detection section 172a (step S402). When the determination shows that the communication apparatus 200 is provided with an image-pickup camera 210, the sequence proceeds to step S403, while when the determination shows that no camera is attached thereto, the sequence proceeds to step S420 at which a usual communication using only voice is carried out.

At step S403, the communication apparatus 100 sends assignment information 103 to the communication apparatus 200. Upon receipt of the assignment information 103, the communication apparatus 200 makes a determination as to whether or not the image-pickup control is in an rejected state by using the image-pickup permission input section 254 (step S404), and if the determination shows the rejected state, the sequence proceeds to step S420, while if the determination shows the non-rejected state, the sequence proceeds to step S405.

At step S405, the communication apparatus 200 gives an image-pickup permission confirming display in the display section 220, thereby requesting the user to operate the image-pickup permission input section 254. Here, if the user rejects the image-pickup control by the other side, he or she selects an input for rejecting the image-pickup control.

At step S406, the communication apparatus 200 makes a determination as to whether or not the user has selected the input for rejecting the image-pickup control, and if the input for rejection is carried out, the sequence proceeds to step S420 at which a usual voice communication is carried out, while if the input for rejection is not carried out, the sequence proceeds to step S407.

At step S407, the communication apparatus 200 makes a determination as to whether or not the user has selected the input for permitting the image-pickup control, and if the input for permission is carried out, the sequence proceeds to step S408 at which the image-pickup control is set in the permitted state, while if the input for permission is not carried out, the sequence returns to step S405 at which the image-pickup permission confirming display is repeated.

At step S408, the communication apparatus 200 records the assignment information 103 thus received in the control information storing section 273. Upon completion of the recording, the communication apparatus 200 makes a transmission to the communication apparatus 100 so as to inform it of the completion of the receiving and recording controls of the assignment information 103 (step S409).

Upon receipt of the information of completion, the communication terminal control section 172 of the communication apparatus 100 displays the guide screen on the display section 120 in which the control operations and the operation methods are given in association with each other (step S410).

Then, the communication terminal control section 172 of the communication apparatus 100 makes a determination as to whether or not the switchover has been made to the second mode for picking up an image by using the image-pickup camera 210 of the communication apparatus 200 on the other side (step S411); thus, if the switchover has been made, the sequence proceeds to step S412, and if the mode change has not been carried out, the sequence proceeds to step S420 at which the usual voice communication is carried out.

At step S412, the user of the communication apparatus 100 refers to the guide screen displayed at step S307, and operates a key included in the ten keys 153 for operating the image-pickup camera 210 of the communication apparatus 200 on the other side.

This operation allows the communication terminal control section 172 to generate a button signal corresponding to the button key thus operated, and also to transmit the button signal to the communication apparatus 200 on the other side (step S413).

Upon receipt of the button signal from the communication apparatus 100, the communication apparatus 200 specifies the operation requested to the image-pickup camera 210 based upon the assignment information 103 that has already been received and recorded, and generates a control signal in accordance with the operation (step S414). In other words, the button signal is converted to a control signal (code) that is effective in the communication apparatus 200.

Based upon the control signal generated by the signal conversion section 276a, the image-pickup section 276 controls the operation of the image-pickup camera 210, and carries out the image-pickup operation in accordance with the control signal (step S415). As a result, the image-pickup camera 210 of the communication apparatus 200 is allowed to pick up an image suitable for the instruction from the communication apparatus 100.

Then, the communication apparatus 200 modulates the image obtained by the image-pickup operation, and transmits this to the communication apparatus 100 (step S416). Consequently, the communication apparatus 100 is allowed to receive the image from the communication apparatus 200 on the other side, and demodulates the received image (step S417). The communication apparatus 100 displays the received image on the display section 120, and allows the user to confirm the image picked up by the apparatus on the other side (step S418).

Thereafter, the sequence proceeds to step S419 at which the communication terminal control section 172 of the communication apparatus 100 makes a determination as to whether or not the next key operation has been carried out. If the next key operation has been carried out, the processes from the step S413 are repeated so that the control operation of the image-pickup camera 210 attached to the communication apparatus 200 is carried out.

In contrast, if the next key operation has not been carried out, the sequence proceeds to step S420, thereby carrying out the usual voice communication.

Here, in this processing sequence, even during the usual communication at step S420, when the user carries out a predetermined operation input on the communication apparatus 100, the sequence returns to step S403 at which the processing sequence for controlling the image-pickup camera 210 of the communication apparatus 200 on the other side so as to pick up an image is again carried out.

The above explanations have dealt with two processing sequences in which the image-pickup permission is automatically given in the communication system 1 and in which the image-pickup permission is manually given; however, these sequences may be easily combined into one sequence.

In this manner, in the communication system 1 of the third preferred embodiment, the communication apparatus 200 that is a control subject is designed so that, in a communicatable connection state to the communication apparatus 100 on the other side, it permits or rejects the control operation of the image-pickup camera 210 by the communication apparatus 100 on the other side; therefore, the communication apparatus 200 becomes possible to prevent the image-pickup camera 210 of its own from being controlled by the communication apparatus 100 on the other side.

Moreover, the image-pickup control permission section 272b of the communication apparatus 200 is designed so that, in the communicatable connection state to the communication apparatus 100 on the other side, it acquires identification information from the communication apparatus 100 on the other side, and permits the control operation of the image-pickup camera 210 if the identification information is coincident with any identification information preliminarily stored therein; thus, by preliminarily registering a communication apparatus 100 that is allowed to image-pickup control the image-pickup camera 210, it is possible to prevent the image-pickup camera 210 from being controlled even when the communication apparatus 200 is made in connection with a communication apparatus other than this.

Moreover, the image-pickup permission input section 254 is installed in the operation input section 250 so that, in a communicatable connection state to the communication apparatus 100 on the other side, an instruction related to permission or rejection to the control operation with respect to the image-pickup camera 210 is given to the image control permission section 272b; therefore, the user of the communication apparatus 200 is allowed to permit or reject the image-pickup control by the communication apparatus 100 on the other side based upon the will of the user of the communication apparatus 200.

In particular, in the case when the selection for rejecting the control of the image-pickup camera 210 by the apparatus on the other side is always set in the image-pickup input section 254 of the operation input section 250, the rejection to the control operation to the image-pickup camera 210 is always given to the image-pickup control permission section 272b with or without the connection to the communication apparatus on the other side; therefore, it is not necessary to hurriedly operate the image-pickup permission input section 254 upon entering a communicatable connection state to an apparatus on the other side (for example, upon receipt of a call), and it is possible to improve the operability.

Here, in the present preferred embodiment, an explanation has been given of the structural example in which the communication apparatus 100 forming a control main body transmits the assignment information 103 to the communication apparatus 200 forming a control subject; however, in the same manner as the first preferred embodiment, the control information 202 may be received from the communication apparatus 200 forming the control subject so as to carry out an image-pickup controlling operation.

<4. Fourth Preferred Embodiment>

Next, an explanation will be given of the fourth preferred embodiment of the present invention. In the above-mentioned preferred embodiments, the explanations have been given of a case in which, for example, the communication apparatuses 100 and 200 are respectively mobile telephones; however, the contents of the above-mentioned preferred embodiments may also be applied to so-called fixed-type TV telephones, etc. Here, in the following explanations, those members having the same structures as those explained in the above-mentioned preferred embodiments are indicated by the same reference numbers, and the description thereof is omitted.

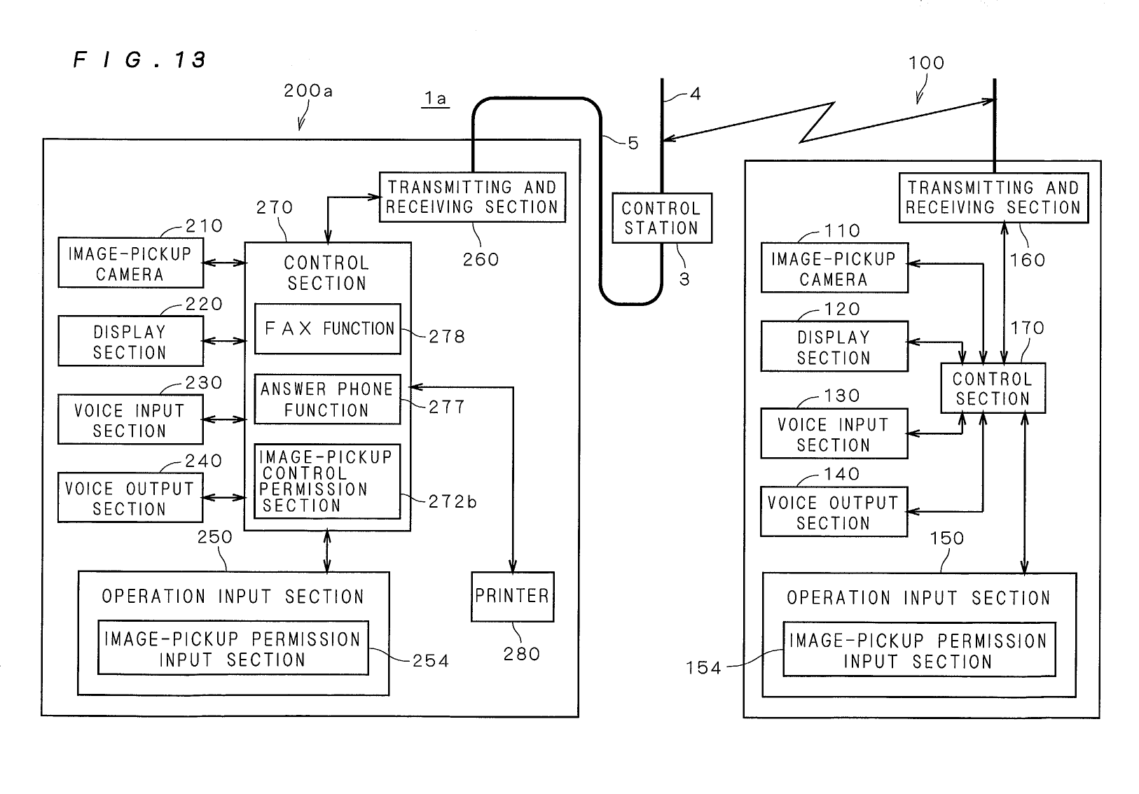

FIG. 13 is a schematic drawing that shows the construction of a communication system 1a in the fourth preferred embodiment. As illustrated in FIG. 13, in this communication system 1a, the two communication apparatus 100, 200a are arranged so as to transmit and receive information through a control station 3. Here, the control station 3 and the communication apparatus 200a are cable-connected through a communication line 5.

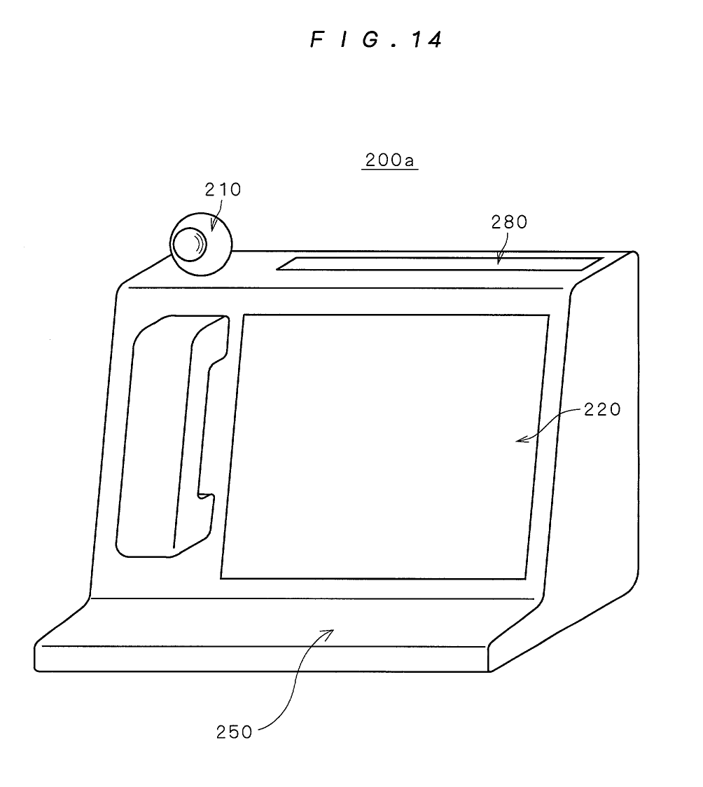

FIG. 14 is a drawing that shows an external appearance of the communication apparatus 200a. As illustrated in FIG. 14, the communication apparatus 200a functions as a so-called fixed-type TV telephone, and placed in an ordinary home, etc. On the upper surface of the communication apparatus 200a, a printer 280 for outputting prints such as documents received through a FAX (facsimile) function and an image-pickup camera 210, which is placed so as to pickup images inside the room, and capable of operations, such as a panning operation, a tilting operation, a zooming operation, a still image releasing operation and a motion image-pickup operation, are placed. Moreover, on the front face side of the communication apparatus 200a, a display section 220 constituted by a liquid crystal display, etc. and a receiver provided with an voice input section 230 and a voice output section 240 are placed. On the lower stage from this, a plurality of button keys, which function as an operation input section 250 through which the caller (user) inputs a desired operation, are placed.

Additionally, the other communication apparatus 100 is the same as that explained in FIG. 2.

Again in FIG. 13, the communication apparatus 200a is constituted by a control section 270 for controlling an image-pickup camera 210, a display section 220, a voice input section 230, a voice output section 240, an operation input section 250 and a printer 280, and a transmitting and receiving section 260 for carrying out transmitting and receiving operations of information with the control station 3 through the communication line 5, which serve as internal functions. Moreover, the control section 270 has functions such as a FAX function 278, an answer phone function 277 and an image-pickup control permission section 272b. The FAX function 278 is a function which, upon receipt of document information from the communication apparatus 100 on the other side, prints these documents. Moreover, the answer phone function 277, which is operated depending on setting operations by the user, is designed so that, upon receipt of a call in the answering state, it automatically responds to the call. Moreover, the image-pickup control section 272b is the same as that explained in the third preferred embodiment.

In this communication system la, an explanation will be given of a case in which, for example, the user of the communication apparatus 100 tries to confirm the state of the inside of his or her own house through the communication apparatus 200a placed in the house, and in such a case, the image-pickup camera 210 of the communication apparatus 200a is controlled and operated by the communication apparatus 100 so that an image required on the communication apparatus 100 side is obtained from the communication apparatus 200a; and the following description will discuss the sequence of processes carried out in this case.

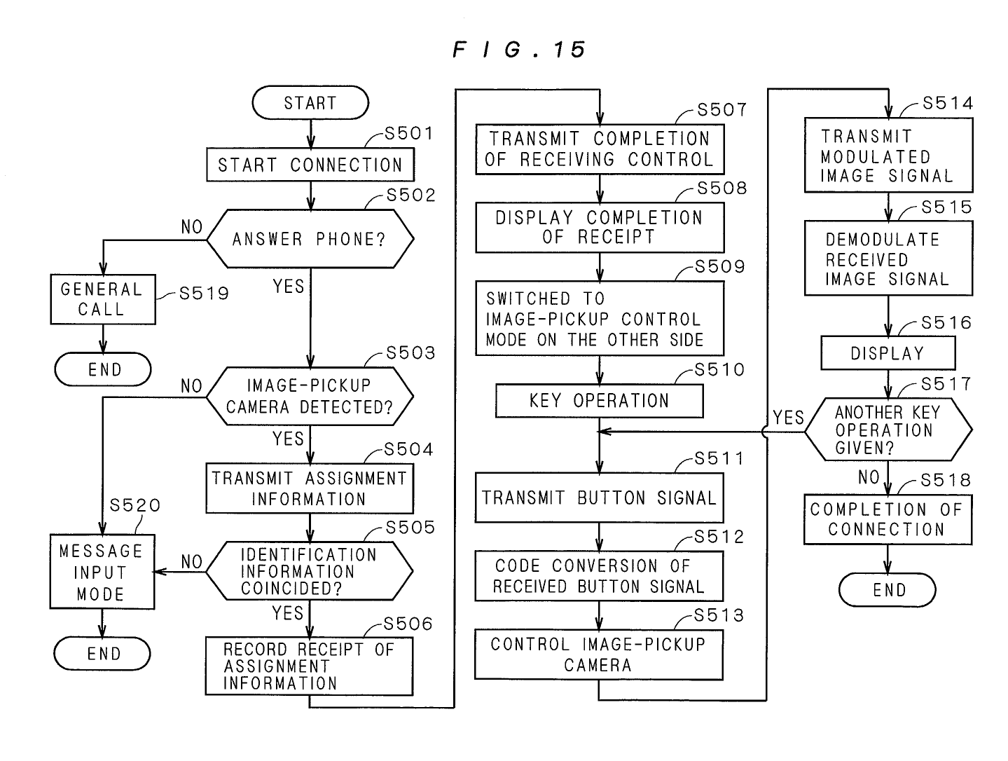

FIG. 15 is a flow chart that shows the sequence of processes in the communication system 1a of the present preferred embodiment.

First, the communication apparatus 100 transmits a request for connection to the communication apparatus 200a, thereby starting a connecting operation so as to provide a mutually communicatable state (step S501).

Then, in the case when the answering phone function 277 of the communication apparatus 200a is functioning effectively, the sequence proceeds to step S503, while in the case when the answering phone function 277 is not functioning, the sequence proceeds to step S519, thereby providing only the usual communication using voice (step S503).

When the sequence has proceeded to step S503, the image-pickup camera detection section 172a functions in the communication apparatus 100 so that a determination is made as to whether or not the communication apparatus 200a on the other side is provided with an image-pickup camera 210. Then, if the determination shows that the communication apparatus 200a has an image-pickup camera 210, the sequence proceeds to step S504, and if the determination shows that it has no image-pickup camera 210, the sequence proceeds to step S520, thereby entering a message input mode carried out by the answering phone function 277.

When the sequence has proceeded to step S504, the communication apparatus 100 transmits assignment information 103 to the communication apparatus 200a. At this time, the communication apparatus 100 simultaneously transmits identification information inherent thereto. Upon receipt of the identification information, the communication apparatus 200a retrieves table data for the identification information (step S505). Here, if any coincident information exists in the table data, it provides a permissible state of the image-pickup control of the image-pickup camera 210 by the communication apparatus 100, and the sequence proceeds to the step S506, while, if no coincident information exists, the sequence proceeds to the step S520, thereby entering the message input mode.

At step S506, the communication apparatus 200a records the assignment information 103 in the control information recording section 273. Upon completion of the recording, the communication apparatus 200a makes a transmission to the communication apparatus 100 so as to inform it of the completion of the receiving and recording controls of the assignment information 103 (step S507).

Upon receipt of the information of completion, the communication terminal control section 172 of the communication apparatus 100 displays a guide screen on the display section 120 in which the control operations and the operation methods are given in association with each other (step S508).

Then, the communication terminal control section 172 of the communication apparatus 100 sends a control permission signal for making a switchover to the mode for picking up an image to the communication apparatus 200a, thereby providing an operation controllable state of the image-pickup camera 210 of the communication apparatus 200a (step S509). Upon receipt of the control permission signal, the communication apparatus 200a allows the control operation of the image-pickup camera 210.

At step S510, the user of the communication apparatus 100 refers to the guide screen displayed at step S508, and operates a key contained in the ten keys 153 for operating the image-pickup camera 210 of the communication apparatus 200a on the other side.

In response to this operation, the communication terminal control section 172 generates a button signal corresponding to the button key thus operated, and transmits this to the communication apparatus 200a on the other side (step S511).

Upon receipt of the button signal from the communication apparatus 100, the communication apparatus 200a specifies the operation requested to the image-pickup camera 210 based upon the assignment information 103 that has been already received and recorded, and generates a control signal in accordance with the operation (step S512). In other words, the button signal is converted to a control signal (code) that is effective in the communication apparatus 200a.

Thus, based upon the control signal generated in the signal conversion section 276a, the image-pickup control section 276 controls the operation of the image-pickup camera 210, and carries out an image-pickup operation based upon the control signal (step S513). Consequently, the image-pickup camera 210 of the communication apparatus 200a picks up an image suitable for the instruction from the communication apparatus 100.

Then, the communication apparatus 200a modulates the image thus picked up and obtained, and transmits this to the communication apparatus 100 (step S514). Consequently, the communication apparatus 100 receives the image from the communication apparatus 200a on the other side, and demodulates the received image (step S515). Then, the communication apparatus 100 displays the image on the display section 120 so that the user is allowed to confirm the image picked up on the other side (step S516).

Then, the sequence proceeds to step S517, and the communication terminal control section 172 of the communication apparatus 100 makes a determination as to whether or not the next key operation has been carried out. Then, if the next key operation has been carried out, the processes from step S511 are repeated so that the operation control of the image-pickup camera 210 attached to the communication apparatus 200a on the other side is carried out.

Here, if no next key operation is carried out, the sequence proceeds to step S518 at which the connected state is terminated.

In this manner, in the communication system 1a of the present preferred embodiment, the communication apparatus 100 makes it possible to control the operation of the image-pickup camera 210 installed in the communication apparatus 200a in which the answering phone function 277 is being exerted, and consequently to allow the user of the communication apparatus 100 to confirm the state of the room in his or her own house from outside.

<5. Modified Examples>

The above description has discussed the respective preferred embodiments of the present invention; however, the present invention is not intended to be limited by the above description.

In the respective preferred embodiments, the explanations have dealt with the case in which the user of the communication apparatus 100 forming a control main body operates the ten keys 153 so as to control the operation of the image-pickup camera 210 of the communication apparatus 200, 200a on the other side; however, the present invention is not intended to be limited by this arrangement. In the case when the communication apparatus 100 forming the control main body is provided with an image-pickup camera 110 together with exclusively-used image-pickup buttons for operating the image-pickup camera 210, the image-pickup buttons are also use so as to control the operation of the image-pickup camera 210 in an attempt to control the operation of the communication apparatus 200, 200a on the other side; thus, the operations carried out when the user of the communication apparatus 100 controls the operation of the image-pickup camera 110 attached to the communication apparatus 100 are provided as the same operations as those of the image-pickup camera 110 attached to the communication apparatus 100. Therefore, it becomes possible to improve the operability.

Moreover, in the above-mentioned preferred embodiments, the explanations have dealt with the case in which the communication apparatus 100 functions as a control main body and the communication apparatus 200, 200a functions as a control subject; however, this relationship may be reversed.

Furthermore, in the above-mentioned preferred embodiments, the explanations have dealt with the case in which both of the two communication apparatuses 100 and 200, which are connected to each other in a communicatable state, are provided with image-pickup cameras; however, the image-pickup camera is not an indispensable element for the communication apparatus 100 forming the control main body, as long as it is provided with at least the display section 120 for display an image.

While the invention has been shown and described in detail, the foregoing description is in all aspects illustrative and not restrictive. It is therefore understood that numerous other modifications and variations can be devised without departing from the scope of the invention.

What is claimed is:

1. A communication apparatus, which communicates with a communication apparatus on the other side, comprising:
a detector which, during a connected state of communication with said communication apparatus on the other side, detects whether or not said communication apparatus on the other side is provided with an image-pickup device;
a control information transmission requesting device which, if said detector detects that said communication apparatus on the other side is provided with said image-pickup device, requests said communication apparatus on the other side to transmit control information for controlling said image-pickup device; and
a control signal transmission device which, after having received said control information requested by said control information transmission requesting device, transmits a control signal for controlling said image-pickup device to said communication apparatus on the other side based upon the control information.

2. The communication apparatus according to claim 1, further comprising:
a display device for displaying an image received from said communication apparatus on the other side.

3. The communication apparatus according to claim 1, further comprising:
a memory for storing said control information obtained by said control information transmission requesting device;
an operation input device having a plurality of operation sections; and
a function assigning device for assigning said control signal contained in said control information to said operation sections.

4. The communication apparatus according to claim 3, wherein said plurality of operation sections are number-inputting-use operation sections used for specifying said communication apparatus on the other side.

5. The communication apparatus according to claim 3, further comprising:
an image-pickup device for picking up an image of a subject,
wherein said plurality of operation sections are image-pickup-use operation sections that are installed so as to operate said image-pickup device attached to its own apparatus.

6. The communication apparatus according to claim 5, further comprising:
a switching device for making a switchover as to which is operated, said image-pickup device of the communication apparatus on the other side or said image-pickup device of its own.

7. The communication apparatus according to claim 1, wherein the operations, carried out at the time when said image-pickup device of said communication apparatus on the other side is controlled, comprise zooming, panning, tilting, still image releasing, and motion image-pickup starting or motion image-pickup terminating operations

8. A communication apparatus, which communicates with a communication apparatus on the other side, comprising:
a detector which, during a connected state of communication with said communication apparatus on the other side, detects whether or not said communication apparatus on the other side is provided with an image-pickup device;
an assignment information transmission device which, if said detector detects that said communication apparatus on the other side is provided with said image-pickup device, transmits to said communication apparatus on the other side assignment information that makes each of the operations of said image-pickup device and each of the operation signals associated with each other; and
a control signal transmission device which, based upon input information from a predetermined operation input device, generates said operation signal to be transmitted to said communication apparatus on the other side.

9. The communication device according to claim 8, wherein said operation input device is a number-inputting-use operation section used for specifying said communication apparatus on the other side so as to carry out a communication with said communication apparatus on the other side.

10. The communication apparatus according to claim 8, further comprising:
a display device for displaying an image received and obtained from said communication apparatus on the other side.

11. The communication apparatus according to claim 8, further comprising:
an image-pickup device for picking up an image of a subject,
wherein said operation input device is an image-pickup-use operation section that is installed so as to operate said image-pickup device attached to its own apparatus.

12. The communication apparatus according to claim 11, further comprising:
a switching device for making a switchover as to which is operated, said image-pickup device of the communication apparatus on the other side or said image-pickup device of its own.

13. The communication apparatus according to claim 8, wherein the operations, carried out at the time when said image-pickup device of said communication apparatus on the other side is controlled, comprise zooming, panning, tilting, still image releasing, and motion image-pickup starting or motion image-pickup terminating operations

14. A communication apparatus, which communicates with a communication apparatus on the other side, comprising:
an image-pickup device for picking up an image of a subject;
a controller for controlling the operation of said image-pickup device; and
an assignment information storage device for storing assignment information that makes each of the operations of said image-pickup device and each of the operation signals associated with each other, obtained from said communication apparatus on the other side,
wherein, upon receipt of an operation signal from said communication apparatus on the other side, said controller specifies the operation of said image-pickup device by reference to said assignment information so that said image-pickup device is controlled so as to carry out the corresponding operation.

15. The communication apparatus according to claim 14, wherein said controller makes a conversion to obtain a control signal that is effective to its own apparatus based upon said operation of said image-pickup device that has been specified, and controls said image-pickup device by using said control signal.

16. A communication apparatus, which communicates with a communication apparatus on the other side, comprising:
an image-pickup device for picking up an image of a subject;
a controller for controlling said image-pickup device based upon a control signal from said communication apparatus on the other side; and
a determination device for permitting or rejecting the controlling operation of said image-pickup device by said controller during a connected state of communication with said communication apparatus on the other side.

17. The communication apparatus according to claim 16, wherein, during the connected state of communication with said communication apparatus on the other side, said determination device obtains identification information from said communication apparatus on the other side, and if said identification information is coincident with any of identification information preliminarily stored, permits the control operation of said image-pickup device.

18. The communication apparatus according to claim 16, further comprising:
an operation input device which, during the connected state of communication with said communication apparatus on the other side, gives an instruction related to said permission or rejection of the control operation to said image-pickup device.

19. The communication apparatus according to claim 16, further comprising:
an operation input device which, with or without the connection to said communication apparatus on the other side, gives an instruction related to said rejection of the control operation with respect to said image-pickup device to said determination device.

20. The communication apparatus according to claim 16, wherein, upon receipt of a predetermined control permitting signal from said communication apparatus on the other side, said determination device permits said control operation of said image-pickup device.

21. The communication apparatus according to claim 16, wherein said control operation to be permitted by said determination device includes zooming, panning, tilting, still image releasing, and motion image-pickup starting or motion image-pickup terminating operations.

22. A mobile communication apparatus comprising:
an image-pickup device for picking up an image of a subject;
an image-pickup mode setting device for making said image-pickup mode for operating said image-pickup device effective; and
a plurality of number-inputting operation sections for specifying said communication apparatus on the other side so as to carry out a communication with said communication apparatus on the other side,
wherein, in the case when said image-pickup mode is set to be effective by said image-pickup mode setting device, said plurality of number-inputting operation sections function as operation input devices for inputting the contents of the operation of said image-pickup device.

23. The mobile communication apparatus according to claim 22, wherein said contents of the operation of said image-pickup device include zooming, panning, tilting, still image releasing, and motion image-pickup starting or motion image-pickup terminating operations.

24. A communication system comprising:
a first communication apparatus; and
a second communication apparatus having an image-pickup device that is designed to communicate with said first communication apparatus,
wherein: said second communication apparatus transmits control information for controlling said image-pickup device to said first communication apparatus in a connected state to said first communication apparatus, and said first communication apparatus transmits a control signal for controlling said image-pickup device to said second communication apparatus based upon said control information so as to control said image-pickup device.

25. The communication system according to claim 24, wherein said first communication apparatus comprises a display device for displaying an image transmitted from said second communication apparatus.

26. A communication system comprising:
a first communication apparatus having a first image-pickup device; and
a second communication apparatus having a second image-pickup device that is designed to communicate with said first communication apparatus,
wherein: said first communication apparatus transmits to said second communication apparatus assignment information that makes each of the operations of said first image-pickup device and each of the operation signals associated with each other, and said second communication apparatus stores the assignment information so that, upon receipt of said operation signal from said first communication apparatus, said second communication apparatus refers to said assignment information and specifies the operation of said second image-pickup device so as to control said second image-pickup device.

27. A communication system comprising:
a first communication apparatus; and
a second communication apparatus having an image-pickup device that is designed to communicate with said first communication apparatus,
wherein said first communication apparatus transmits a control signal to said second communication apparatus, and said second communication apparatus comprises:
a controller for controlling said image-pickup device based upon said control signal; and
a determination device for permitting or rejecting the controlling operation of said image-pickup device by said controller during a connected state of communication with said first communication apparatus.

28. The communication system according to claim 27, wherein said first communication apparatus comprises a display device for displaying an image transmitted from said second communication apparatus.
